(19) United States
(12) Patent Application Publication
(10) Pub. No.: US 2025/0145028 A1
(43) Pub. Date: May 8, 2025

(54) EV CHARGER WITH V2V CHARGING CAPABILITY

(71) Applicant: ALPITRONIC SRL, Bolzano (IT)

(72) Inventor: Philipp Niedermayr, Eppan (IT)

(73) Assignee: ALPITRONIC SRL, Bolzano (IT)

(21) Appl. No.: 18/915,802

(22) Filed: Oct. 15, 2024

Related U.S. Application Data
(60) Provisional application No. 63/544,198, filed on Oct. 15, 2023.

(51) Int. Cl. B60L 53/10; B60L 53/53

(52) U.S. Cl. CPC B60L 53/10; B60L 53/53; B60L 2210/10; B60L 2210/30

(57) ABSTRACT

An EV charger has an AC-DC converter coupled to two DC-DC converters can be configured with V2V charging capability, together with a wide range of input/output voltages for accepting existing electric vehicle available on the market. The charger can include a variable transformer to partition the output voltage range into multiple subranges. In addition, the switching frequency of the DC-DC converter can be doubled when the voltage gain of the DC-DC converter deviates significantly from unity.

### CROSS-REFERENCE TO RELATED APPLICATION

This application claims benefit under 35 U.S.C. § 119 (e) to U.S. Provisional Application No. 63/544,198, filed Oct. 15, 2023, entitled “EV CHARGER WITH V2V CHARGING CAPABILITY,” the entire disclosure of which is hereby incorporated by reference herein.

### BACKGROUND OF THE INVENTION

This invention relates to the field of electric vehicle (EV) charging equipment and more specifically to EV supply equipment (EVSE), e.g., a charger, configured to charge one or two electric vehicles simultaneously, together with the ability of vehicle-to-vehicle charging.

There is a continuing trend in the power conversion industry to provide DC/DC converters with improved efficiency and power density characteristics. The ever increasing efficiency requirements have pushed the limits of these DC-DC converter topologies to be above 95%, or close to 98%. Furthermore the requirements for high output power have reached charging currents of more than 100 Amps, which requires a high efficiency just to keep the charger from overheating.

Further, there is a need for charging one electric vehicle from another electric vehicle (V2V charging), for example, at remote area when there is no grid power.

Thus, there is a need for high efficiency chargers, for example, for chargers installed in public places and configured to charge all type of electric vehicles, together with a capability of V2V charging.

### SUMMARY OF THE EMBODIMENTS

In some embodiments, the present invention discloses a charger for electric vehicles configured with V2V charging capability, together with a wide range of input/output voltages for accepting existing electric vehicle available on the market.

The charger can be configured to provide a broad output at the vehicle side for handling electric vehicles with different battery voltages, such as battery voltages in a voltage range of 50V-1000V. To ease the efficiency design, the charger can include a variable transformer to partition the output voltage range into multiple subranges. For example, the voltage range of 50V-1000V can be partitioned into two subranges of 50V-500V and 500V-1000V, using two transformer ratios of 1:1 and 2:1.

In addition, the switching frequency of the DC-DC converter can be doubled to reduce the peak current in the semiconductor and the transformer, when the voltage gain of the DC-DC converter deviates significantly from unity.

The charger can be configured with 2 outputs, which can be configured for multiple modes of charging, including charging a single electric vehicle using power from one DC-DC converter, e.g., using half the capacity of the charger, charging a single electric vehicle using power from two DC-DC converters, e.g., using the whole capacity of the charger, charging two electric vehicles simultaneously, and charging one electric vehicle from another electric vehicle.

Advantages of the charger offering vehicle-to-vehicle (V2V) charging include charging electric vehicles when there is no available grid connection, such as at locations far away from the grid or when there is a power outage resulting in a loss of grid power. For example, a service vehicle with a charger installed, for example, in the trunk of the service vehicle, can be driven to the empty-battery vehicle to charge the empty-battery vehicle. The charging process can use the battery of the service vehicle, e.g., the service vehicle can be an electric vehicle with its battery fully charged. The charging process can use an external battery, which is also installed in the service vehicle.

Other advantages include places where vehicles are parked for long periods of time, such as at the parking garages of an airport or a train station. An intelligent charging system could extract energy from a vehicle that is parked for a longer period of time to charge a vehicle that will be moved again shortly. This can prevent having to draw expensive energy from the grid at peak times. The discharged vehicle can then be recharged with cheap energy at night, for example.

Other advantages include a very high efficiency, such as about 98%, due to the bypassing of the AC-DC converter stage. In the V2V process, only 2 DC-DC converters are used, e.g., power from an electric vehicle is converted by a DC-DC converter to a common voltage, such as at the DC link capacitor. The power is then converted by another DC-DC converter to the battery voltage of the other electric vehicle.

### BRIEF DESCRIPTION OF THE DRAWINGS

FIGS. 1A-1D illustrate configurations of a charger according to some embodiments.

FIGS. 2A-2D illustrate charging configurations for a charger according to some embodiments.

FIGS. 3A-3B illustrate flow charts for forming a charger according to some embodiments.

FIGS. 4A-4D illustrate flow charts for operating a charger according to some embodiments.

FIGS. 5A-5B illustrate a configuration for a charger capable of charging electric vehicles having a wide voltage range with high efficiency according to some embodiments.

FIGS. 6A-6C illustrate an operation of an AC-DC converter having a variable output voltage according to some embodiments.

FIGS. 7A-7F illustrate an operation of a DC-DC converter having an optimum efficiency according to some embodiments.

FIGS. 8A-8C illustrate an operation of a DC-DC converter having a variable transformer according to some embodiments.

FIG. 9 illustrates an operation of a charger having a wide output voltage range with high efficiency according to some embodiments.

FIG. 10 illustrates a schematic of a charger having a wide output voltage range with high efficiency according to some embodiments.

FIG. 11 illustrates a flow chart for forming a charger having a wide output voltage range with high efficiency according to some embodiments.

FIG. 12 illustrates a flow chart for operating a charger having a wide output voltage range with high efficiency according to some embodiments.

FIG. 13 illustrates a schematic of a charger having two outputs according to some embodiments.

FIGS. 14A-14C illustrate operating configurations for a charger having two outputs for charging one or two electric vehicles according to some embodiments.

FIG. 15 illustrates a flow chart for forming a charger having two outputs according to some embodiments.

FIGS. 16A-16C illustrate flow charts for operating a charger having two outputs for charging two electric vehicles according to some embodiments.

FIGS. 17A-17B illustrate a configuration for a charger capable of vehicle-to-vehicle charging according to some embodiments.

FIG. 18 illustrates a schematic with an operating sequence for a charger capable of vehicle-to-vehicle charging according to some embodiments.

FIG. 19 illustrates a flow chart for forming a charger capable of vehicle-to-vehicle charging according to some embodiments.

FIG. 20 illustrates a flow chart for vehicle-to-vehicle charging using a charger capable of vehicle-to-vehicle charging according to some embodiments.

### DETAILED DESCRIPTION OF THE EMBODIMENTS

In some embodiments, the present invention discloses a charger for electric vehicles, e.g., a power conversion module configured to receive power from a grid such as AC power, and to convert the receive AC power to DC power suitable to charge the electric vehicles. The charger can be configured with 2 outputs, which can charge two electric vehicles simultaneously, in addition to other charging configurations such as charging a single electric vehicle with power from one output, charging a single electric vehicle, with power from both outputs, and charging one electric vehicle from another electric vehicle without the grid connection.

### Broad Output Range

### Charger

The charger can be configured to provide a broad output at the vehicle side for handling electric vehicles with different battery voltages, such as battery voltages in a voltage range of 50V-1000V. The charger can be designed to have high efficiency at most of the voltages in the voltage range, and acceptable efficiency at other voltage values. For example, the values of the charger efficiency can be based on the popularity of the electric vehicles, such as based on a probability distribution of battery voltage values for available electric vehicles. For example, there are few electric vehicles with battery voltages in a voltage range of 50V-150V, so the charger can be designed to have higher efficiency at the voltage range of 150V-1000V.

To improve the efficiency, the charger can include a variable transformer. In DC-DC converters, such as dual active bridge (DAB) converter, high efficiency can be achieved when the ratio of Vout over Vin in the DC-DC converter is close to unity. In the case of an isolated DC-DC converter using a transformer, the high efficiency can be achieved when the ratio of Vout/Vin is close to the transformer winding ratio n, with n being the ratio of the primary winding, e.g., the input side of the DC-DC converter, over the secondary winding, e.g., the output side of the DC-DC converter.

For practical reasons, e.g., for simplicity and cost effective designs, the charger can have a transformer with two winding ratios, which can effectively partition the output voltage range into two subranges with equal efficiency using a same DC input voltage range. For example, for an input voltage range of 500V-1000V to the DC-DC converter, the output voltage range of 50V-1000V can be partitioned into two subranges of 50V-500V and 500V-1000V. Using two transformer ratios of 1:1 and 2:1, the battery voltage ranges of 250V-500V and 500V-1000V have similar efficiency. And, as discussed above, fewer electric vehicles have battery voltages in the subrange of 50V-250V, and thus, low efficiency at this subrange presents a const effective solution for the charger.

For example, the transformer can include two sets of primary winding and also two sets of secondary windings, with each winding having a same number of turns. The two primary sets of windings are connected in series. When the two sets of secondary windings are connected in series, the transformer provides a ratio of 1:1. When the two sets of secondary windings are connected in parallel, the transformer provides a ratio of 2:1.

The DC input voltage range can be reduced, for example, to 600V-900V, to improve an efficiency of an AC-DC converter, which is used in the charger to convert an AC voltage from the grid to the DC input voltage. Using a transformer ratio of 1:1, the battery voltage range of 600V-900V can have high efficiency due to a unity voltage gain of the DC-DC converter. The battery DC voltage ranges of 500V-600V and 900V-1000V can have a little lower efficiency due to the deviation of the voltage gain from unity. Advanced switching schemes can be used to improve the efficiency in these voltage ranges.

Using a transformer ratio of 2:1, the battery voltage range of 250V-500V can be similar, e.g., having similar efficiency. For example, the voltage range of 300V-450V can have high efficiency since the voltage gain is close to the transformer ratio. The voltage ranges of 250V-300V, and the voltage range of 450V-500V can have a little lower efficiency, which can be improved using advanced switching schemes. In addition, the voltage range of 50V-250V can be partitioned into two subranges, such as 50V-150V and 150V to 250V. The subrange of 150V-250V can have acceptable efficiency, since the deviation of the voltage gain to the transformer ratio is not excessively large. Thus, the voltage subrange of 150V-250V can be treated as the voltage range of 250V-300V.

For the voltage subrange of 50V-150V, since the deviation of the voltage gain to the transformer ratio is larger than 2, the switching frequency of the DC-DC converter can be doubled to reduce the peak current in the semiconductor and the transformer, including the magnetic flux) in the DC-DC converter. The efficiency is a little lower than other battery voltage ranges, but with a low probability of electric vehicles having this battery voltage range, it can be a cost effective solution in an attempt to provide charger services to as many electric vehicles as possible.

### Operation

The charger can be configured allow measuring the battery voltage of the electric vehicle coupled to the charger. For example, an output of the DC-DC converter can be coupled to a terminal of a controllable switch, such as a relay or a MOSFET. The other terminal of the controllable switch is configured to be coupled to the electric vehicle, such as a coupling to a handle of the charger. In operation, the charger handle is coupled to the electric vehicle, and the battery voltage of the electric vehicle can be measured, for example, by turning off the controllable switch. In practice, the controllable switch is normally off, which can serve as a safety feature for the charger. Thus, the vehicle battery voltage can be measured after the charger handle is coupled to the electric vehicle. After the charger is ready to charge the electric vehicle, for example, after selecting the appropriate transformer ratio, after setting the switching signal for the AC-DC converter to generate appropriate DC input voltage to the DC-DC converter, and after setting the switching signal for the DC-DC converter such as setting the appropriate switching frequency, the controllable switch can be turned on to start charging the electric vehicle. During charging, feedback voltage from the vehicle battery can be used to control the charging characteristics, such as characteristics of the switching signals for the AC-DC converter or for the DC-DC converter.

The charger can include a controller, configured to obtain a voltage of an electric vehicle coupled to the charger. The controller is also configured to control the transformer ratio, the switching signal of the AC-DC converter, and the switching signal of the DC-DC converter based on the obtained voltage. The controller is further configured to control the controllable switch, such as to turn on the controllable switch after the charger conditions are set, and to turn off the controllable switch after the charger finishes charging the electric vehicle. The controller is also configured to regulate the switching signal of the AC-DC converter, and the switching signal of the DC-DC converter to provide an appropriate charging current to the electric vehicle during the charging session.

### Charging Configuration

The charger with two outputs, e.g., two DC-DC converters coupled to an AC-DC converter, can be configured for multiple modes of charging, including charging a single electric vehicle using power from one DC-DC converter, e.g., using half the capacity of the charger, charging a single electric vehicle using power from two DC-DC converters, e.g., using the whole capacity of the charger, charging two electric vehicles simultaneously, and charging one electric vehicle from another electric vehicle.

Single Electric Vehicle Charged with Power from One DC-DC Converter

The charger can be configured to charge a single electric vehicle coupled to one output of the charger, using power from one DC-DC converter. First, the battery voltage of the electric vehicle is measured by the charger. The battery voltage is used to set the transformer ratio, such as the ratio is set at 1:1 for the battery voltage in a range of 500V-1000V, and the ratio is set at 2:1 for the battery voltage in a range of 50V-500V. The DC output of the AC-DC converter is set to be closest to the battery voltage when the ratio is 1:1 and set to be closest to half of the battery voltage when the ratio is 2:1. If the ratio of the battery voltage and the DC output voltage of the AC-DC converter is slightly different from the transformer ratio, such as differed by less than 2×, advanced switching scheme can be used in the DC-DC converter to further optimize the efficiency of the DC-DC converter. If the ratio of the battery voltage and the DC output voltage of the AC-DC converter is significantly different from the transformer ratio, such as differed by more than 2×, the switching frequency of the DC-DC converter is doubled, in addition to any advanced switching scheme.

The controllable switch connecting the output of the DC-DC converter to the output of the charger is turned on, to deliver charging power to the electric vehicle. Close loop feedback can be used to ensure a stable voltage charging, such as regulating the AC-DC and the DC-DC converters based on the battery voltage during the charging operation. After charging is completed, the controllable switch is turned off, to isolate the charger output, such as at the charger handle.

Single Electric Vehicle Charged with Power from Two DC-DC Converters

The charger can be configured to charge a single electric vehicle coupled to one output of the charger using power from two DC-DC converters, e.g., doubling the power from one DC-DC converter.

First, the battery voltage of the electric vehicle is measured by the charger. The battery voltage is used to set the transformer ratio, such as the ratio is set at 1:1 for the battery voltage in a range of 500V-1000V, and the ratio is set at 2:1 for the battery voltage in a range of 50V-500V. The DC output of the AC-DC converter is set to be closest to the battery voltage when the ratio is 1:1 and set to be closest to half of the battery voltage when the ratio is 2:1. If the ratio of the battery voltage and the DC output voltage of the AC-DC converter is slightly different from the transformer ratio, such as differed by less than 2×, advanced switching scheme can be used in the DC-DC converter to further optimize the efficiency of the DC-DC converter. If the ratio of the battery voltage and the DC output voltage of the AC-DC converter is significantly different from the transformer ratio, such as differed by more than 2×, the switching frequency of the DC-DC converter is doubled, in addition to any advanced switching scheme.

The process is duplicated for the second DC-DC converter, except for the setting of the DC output of the AC-DC converter, since there is typically one AC-DC converter coupled to two DC-DC converters. Thus, in the second DC-DC converter, the transformer ratio is set, advanced switching scheme is applied, and switching frequency is set, similar to the first DC-DC converter.

A parallel circuit connecting the two DC-DC converters is activated, e.g., the outputs of the DC-DC converters are coupled together so that the power from the two DC-DC converters is provided to the single electric vehicle. The parallel circuit can include a set of relays or MOSFETs, which is activated by a controller. The parallel circuit can be coupled to the DC-DC converters before or after the controllable switches isolating the DC-DC converters from the electric vehicle.

The controllable switch connecting the output of the DC-DC converter to the output of the charger is turned on, to deliver charging power to the electric vehicle. Close loop feedback can be used to ensure a stable voltage charging, such as regulating the AC-DC and the DC-DC converters based on the battery voltage during the charging operation. After charging is completed, the controllable switch is turned off, to isolate the charger output, such as at the charger handle. The parallel circuit is also deactivated.

### Two Electric Vehicles Simultaneously Charged

The charger can be configured to simultaneously charge two electric vehicles coupled to two outputs of the charger, respectively. Each electric vehicle is charged from the corresponding DC-DC converter.

First, the battery voltages of the electric vehicles are measured by the charger. The battery voltages are used to determine the individual characteristics of the two DC-DC converters, subjected to a constraint of a common DC output voltage from the AC-DC converter. For example, the efficiency of the charger can be determined by optimizing the individual efficiencies of the DC-DC converters, such as setting the appropriate transformer ratios, determining the appropriate DC output voltages from the AC-DC converter, and setting the switching frequencies in the DC-DC converters. A common DC output voltage is then calculated from the two DC output voltages determined from the optimization of the two DC-DC converters using a requirement of a maximum efficiency for both DC-DC converters, such as sum of two individual efficiencies. The calculation can be an iteration process to optimize the efficiencies for both DC-DC converters. For example, an average value for the DC output voltages can be used as an initial value for the optimization of a common DC output voltage. The initial value can be varied to obtain the maximum efficiency for the charger.

The controllable switches connecting the outputs of the DC-DC converters to the outputs of the charger are turned on, to deliver charging power to the electric vehicles. Close loop feedback can be used to ensure a stable voltage charging. After charging is completed, the controllable switches are turned off.

Charging One Electric Vehicle from Another Electric Vehicle

The charger can be configured to use power from one electric vehicle to charge another electric vehicle, with the two electric vehicles coupled to two outputs of the charger, respectively. Important elements for this configuration include a common DC link capacitor and bidirectional DC-DC converters. The common DC link capacitor is coupled to the DC output of the AC-DC converter, at which the inputs of the DC-DC converters are coupled to. The bidirectional DC-DC converters allow the power transfer in both directions, e.g., from the inputs of the DC-DC converters to the outputs of the DC-DC converters, and vice versa. The AC-DC converter can be bidirectional or non-bidirectional.

In operation, the power flows of the DC-DC converters are controlled by the phase shift in the pulse width modulation (PWM) pattern between the primary side and the secondary side of the DC-DC converters. If the phase shift is positive, the output current is positive. If the phase shift is negative, the output current is negative. Thus, the signs of the output currents control whether the DC-DC converters are charging or discharging.

The battery voltages of the electric vehicles are then measured by the charger. The battery voltages are used to determine the individual characteristics of the two DC-DC converters, subjected to a constraint of a common voltage at the connection of the two DC-DC converters, as discussed above, except for the control of the AC-DC converter, which is turned off. For example, the AC-DC converter is disconnected from the grid, for example, by one or more controllable switches coupling the AC-DC converter to the grid. The common voltage at the connection of the two DC-DC converters is obtained as a result of the power flow from one DC-DC converter to another DC-DC converter. Due to the ability to switch the winding ratio of the transformers and the clock frequency of the DC-DC converters, two vehicles with completely different battery voltages can be connected through the common voltage at the connection of the two DC-DC converters.

The controllable switches connecting the outputs of the DC-DC converters to the outputs of the charger are turned on, to enable the charging of one electric vehicle from the other electric vehicle. Close loop feedback can be used to ensure a stable voltage charging. After charging is completed, the controllable switches are turned off.

### General Charger for Charging One or Two Electric Vehicles, and Also for Vehicle to Vehicle Charging

In some embodiments, the present invention discloses a charger, e.g., a charging device, having a wide range of output voltages suitable for interfacing with existing electric vehicles. A primary function of the charger is to recharge batteries from the electricity available on an electrical distribution grid. The charger thus includes an alternate current to direct current (AC-DC) converter configured to be coupled to the grid having one phase or three phase output. The AC-DC converter is coupled to one or more direct current to direct current (DC/DC) converters configured to generate a variable DC output range. The charger exhibits a high efficiency, a low bulk, good galvanic insulation, good reliability, high operating safety, a low emission of electromagnetic disruptions, and a low harmonic ratio on the input current.

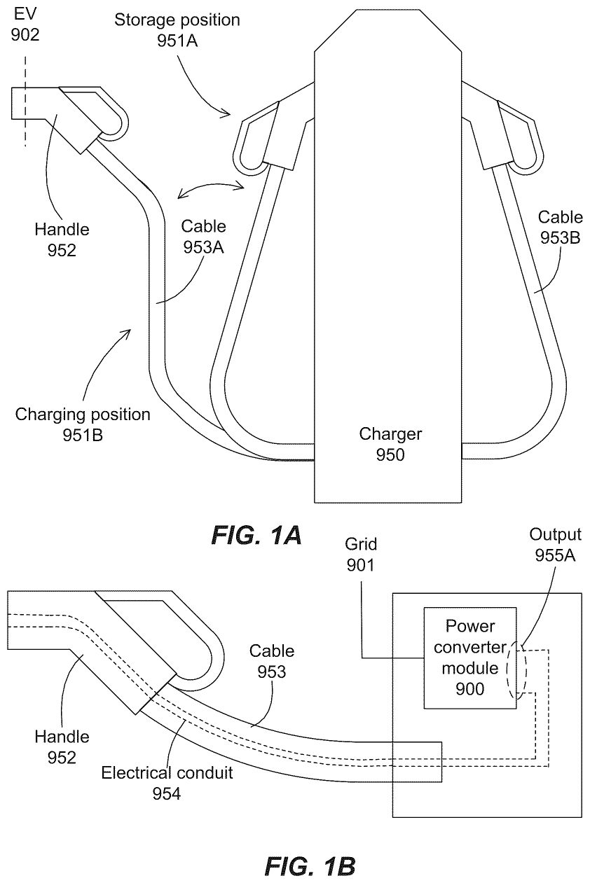

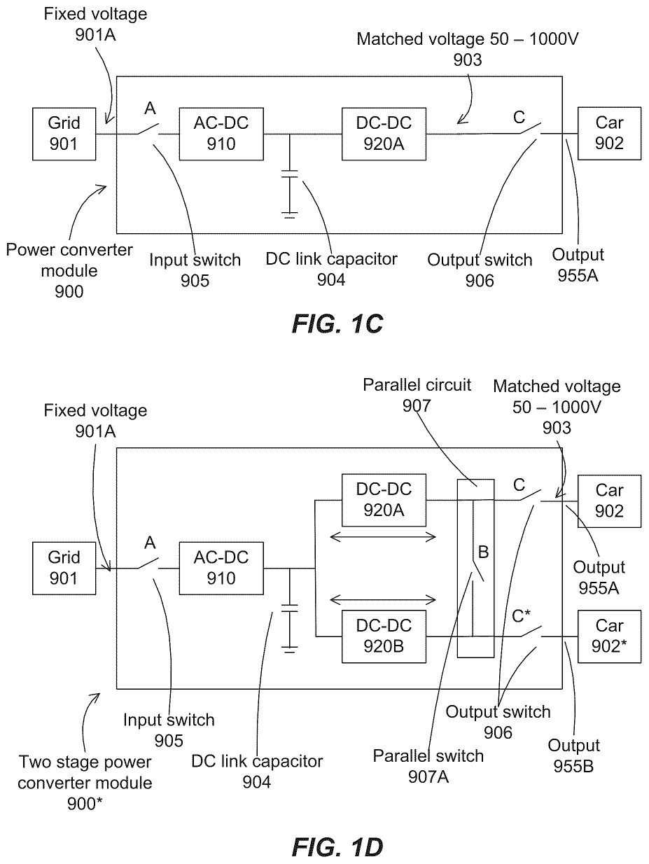

FIGS. 1A-1D illustrate configurations of a charger according to some embodiments. FIG. 1A shows a charger 950 configured with two cables 953A and 953B for carrying electrical currents to electric vehicles 902. At one end of each cable, there is a connector having a handle 952. The connector is designed so as to be compatible with a charging inlet or socket on an electric vehicle, and can therefore be configured according to one or more standards for electric connectors. The handle is designed for a user to handle the charging cable, such as to remove the cable from a storage position 951A to a charging position 951B to charge the electric vehicle. The other end of the cable opposite the handle is assembled into a body of the charger, such as to connect the electrical conduits 954, which typically is a copper wire, in the cable with the power converter module 900. The power converter module 900 includes at least an output 955A, which is coupled to the electrical conduit 954 to the handle 952.

The cable with the handle can normally be positioned in a storage position 951A, in which the handle is housed in a handle holder in the charger. An electric vehicle 902 can be positioned near the charger to have its battery charged. When the electric vehicle 902 is ready, the handle is removed from the handle holder, to be coupled with the socket of the electric vehicle, in a charging position 951B. The cable is typically long enough to allow the electric vehicle to park at a distance less than the length of the cable, to be reached by the cable.

For example, the charger can be designed for one or more types of electric vehicles, such as a charger installed at a private or public location. A charging cable 953A is shown to connect the charger 950 with the electric vehicle 902. One end of the charging cable is permanently attached to the charger. At the time of charging, a user removes the charging cable at the handle to attach the handle to the socket, e.g., a charge port of the electric vehicle.

FIG. 1B shows a schematic of a charger, which is also called an electric vehicle supply equipment EVSE, and which can be used to charge a battery, such as a battery in an electric vehicle. The electric vehicles can include electric cars, neighborhood electric vehicles, fork lifts, plug-in hybrids, or any moving system having an operating battery.

The charger can include a power converter module 900, which is configured to receive electric power from an external power supply, such as from a generator or an electric grid 901, which can be 340-550 VAC, 1 to 3 phases. The power converter unit then conditions the supplied power so as to deliver the proper electric energy to the electric vehicle, e.g., converting the grid power to a voltage suitable to charge the battery of the electric vehicle, which can be 50-1000 VDC, depending on the batteries of the electric vehicle connected to the charger. For example, incoming AC power from the grid can be converted to a suitable form of DC for direct charging the battery. The cable can include a ground conductor, which can be connected to a ground terminal in the charger. During charging, the ground conductor can be connected to a corresponding ground terminal in the electric vehicle, such as to the vehicle chassis.

Each electric vehicle has a battery having a defined rated voltage. For example, an electric vehicle having a 400V-battery can accept a charging DC voltage range of about 300V to 450V, and an electric vehicle having an 800V-battery can accept a charging DC voltage range of about 600V to 850V. At present, the popular rated voltage for batteries of electric vehicles is 400 V-800V, but electric vehicles having different battery voltages are also known, such as a limited number of electric vehicles having a battery voltage in the range of 50V-150V. Higher battery voltages, such as a battery having a rated voltage of 800V, can provide a higher power density, such as than a battery having a rated voltage of 400V, of the same size. Further, higher battery voltages can result in lower current, leading to a reduction in the size of the current carrying conductors.

The charger can be installed in public space such as parking lots or at private premises. Each charger can be equipped with one or two charging cables, each includes a charging connector for interfacing with an electric vehicle. There is a need for rapid charging of the battery of the electric vehicle, e.g., the charging time needs to be so that a user would find it acceptable for waiting for the electric vehicle to be charged. In general, the charging time is governed by the voltage and the amount of current that a charger system can deliver to the battery through the charging cable, which can be a limiting factor for increasing the delivering current.

For rapid charging operations, particularly high currents must be used, e.g., the current generated by the power converter and carried by the electrical conduits in the cable can be high, e.g., above 100 A or 200 A, and can reach 500 A to 1000 A. As such, the charger is designed with high efficiency, such as greater than 90%, greater than 95% or 96%, or about 98% in some cases such as vehicle-to-vehicle (V2V) charging. With high efficiency for a wide range of DC output voltages, together with a cost effective design, the present charger can possess a design innovation for charger configurations.

FIG. 1C shows a schematic for a power conversion module 900 having one output. The module include an input power interface being connectable to a power source such as the grid, an AC-DC converter 910 for rectification of the AC voltage from a power grid 901, a DC-DC converter 920A connected to the AC-DC converter for battery current and voltage regulation, and an output power interface connected to the DC-DC-converter and configured to be connected to the battery of the electric vehicle. Other circuits can be included, such as a Power Factor Correction (PFC).

The module is configured to be coupled to the grid 901, which can be a single phase or three phase power, providing a fixed voltage 901A, such as 340-550 VAC. The input power interface can include an input switch A 905, which is coupled between the input of the AC-DC converter to the input of the module 900, which can serve to isolate the module from the grid, for example, to turn off the charger. A DC link capacitor 904 can be coupled between the output of the AC-DC converter and the input to the DC-DC converter, for example, to regulate the rectified output voltage from the AC-DC converter.

The output power interface can include an output switch C 906, which is coupled between the output 903 of the DC-DC converter to the output 955A of the module 900, and which can serve to isolate the module from the electric vehicle 902, for example, to measure the battery voltage of the electric vehicle. The DC-DC converter can be configured to deliver a voltage in a range of 50V to 1000V, which is designed to match with the measured battery voltage of the electric vehicle.

FIG. 1D shows a schematic for a power conversion module 900* having two outputs. The module include an input power interface being connectable to a power source such as the grid, an AC-DC converter 910 for rectification of the AC voltage from a power grid 901, two DC-DC converters 920A and 920B connected to the AC-DC converter for battery current and voltage regulation, a parallel circuit 907 coupled to the outputs of the DC-DC converters for controllably connecting the outputs, and an output power interface connected to the DC-DC-converters and configured to be connected to the battery of the electric vehicle. The DC-DC converters can be bidirectional DC-DC converters, which can allow the power flow in both directions, such as to the electric vehicle or from the electric vehicle. The AC-DC converter can be non bidirectional to lower the cost of the module. Alternatively, the AC-DC converter can also be bidirectional to allow a returning of power to the grid. Other circuits can be included, such as a Power Factor Correction (PFC).

The module 900* is configured to be coupled to the grid 901, providing a fixed voltage 901A, such as 340-550 VAC, 1 or 3 phases. The input power interface can include an input switch A 905, which is coupled between the input of the AC-DC converter to the input of the module 900. A DC link capacitor 904 can be coupled between the output of the AC-DC converter and the inputs to the DC-DC converters.

The parallel circuit 907 can include a relay B, which serves as a parallel switch 907A connecting the outputs of the DC-DC converters. Other configurations for the parallel circuit can be used, such as a MOSFET functioning as a switch. As shown, the parallel circuit is coupled directly to the outputs of the DC-DC converters. Other configurations can be used, such as a parallel circuit coupled between the outputs 955A and 955B of the module 900*, e.g. indirectly coupled to the outputs of the DC-DC converters through the output switches 906.

The output power interface can include a first output switch C 906, which is coupled between the output of the DC-DC converter 920A to the output 955A of the module 900*, and a second output switch C* 906, which is coupled between the output of the DC-DC converter 920B to the output 955B of the module 900*. Each DC-DC converter can be configured to deliver a voltage in a range of 50V to 1000V.

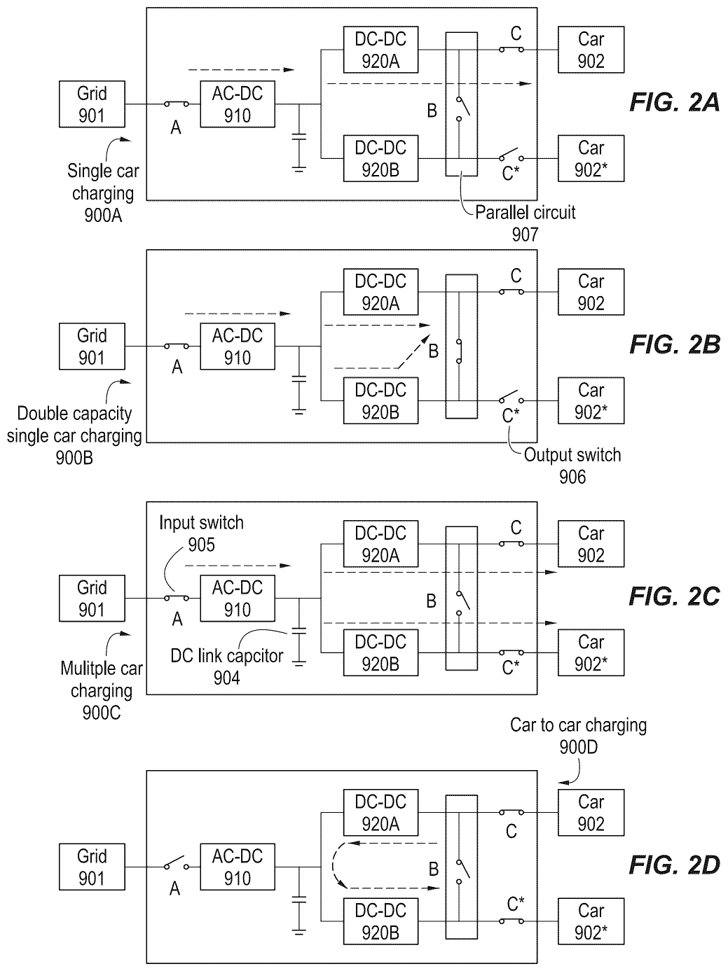

FIGS. 2A-2D illustrate charging configurations for a charger according to some embodiments. A charger can be configured with two outputs, e.g., two DC-DC converters coupled to an AC-DC converter, to provide multiple modes of charging, such as charging a single electric vehicle using power from one DC-DC converter (FIG. 2A), charging a single electric vehicle using power from two DC-DC converters (FIG. 2B), charging two electric vehicles simultaneously (FIG. 2C), and charging one electric vehicle from another electric vehicle (FIG. 2D).

A charger, represented by a power converter module, can include an input switch A coupled to an AC-DC converter 910. The output of the AC-DC converter is coupled to 2 DC-DC converters 920A and 920B, with a DC link capacitor. A parallel circuit 907 having a switch B is coupled between the outputs of the DC-DC converters. Switches C and C* are individually coupled to the outputs of the DC-DC converters, respectively.

As shown in FIG. 2A, a charger can be configured for single vehicle charging using only a portion of the power of the charger, such as half the power amount, by using only one DC-DC converter 920A. An electric vehicle 902 is coupled to an output of the charger. The parallel switch B is turned off, for example, the switch is normally off, to isolate the two outputs of the DC-DC converters. The output switch C is turned on, together with the input switch A. Power is delivered from the grid 901, through the input switch A, rectified by the AC-DC converter 910, and conditioned by the DC-DC converter 920A, and then through the output switch C to charge the electric vehicle 902.

As shown in FIG. 2B, a charger can be configured for single vehicle charging using the full power of the charger, by using both DC-DC converters 920A and 920B. An electric vehicle 902 is coupled to an output of the charger. The parallel switch B is turned on to connect the two DC-DC converters so that power from both DC-DC converters can be delivered to the electric vehicle. The output switch C is turned on, together with the input switch A. Power is delivered from the grid 901, through the input switch A, rectified by the AC-DC converter 910, and conditioned by the DC-DC converters 920A and 920B, merged together, and then through the output switch C to charge the electric vehicle 902.

As shown in FIG. 2C, a charger can be configured for charging two vehicles 902 and 902* simultaneously, by using each DC-DC converter 920A or 920B to charge an electric vehicle. Electric vehicles 902 and 902* are each coupled to an output of the charger. The parallel switch B is turned off to isolate the two DC-DC converters. The output switches C and C* are turned on, together with the input switch A. Power is delivered from the grid 901, through the input switch A, rectified by the AC-DC converter 910, and conditioned by the DC-DC converters 920A and 920B, and then through the output switches C and C* to charge the electric vehicles 902 and 902* separately.

As shown in FIG. 2D, a charger can be configured for V2V charging, e.g., charging one vehicle 902* from the power of another vehicle 902, by configuring the power flow of each DC-DC converter 920A or 920B, such as setting a reverse flow for the DC-DC converter 920A and a forward flow for the DC-DC converter 920A. Electric vehicles 902 and 902* are each coupled to an output of the charger. The parallel switch B is turned off to isolate the two DC-DC converters. The output switches C and C* are turned on, and the input switch A is turned off. Power is delivered from the electric vehicle 920, through the output switch C, conditioned by the DC-DC converters 920A to reach a common voltage at the DC link capacitor, conditioned by the DC-DC converters 920B, and then through the output switch C* to charge the electric vehicle 902*.

As shown, the power flow involves only the two DC-DC converters without using the AC-DC converter. Thus, the efficiency can be very high, such as about 98%.

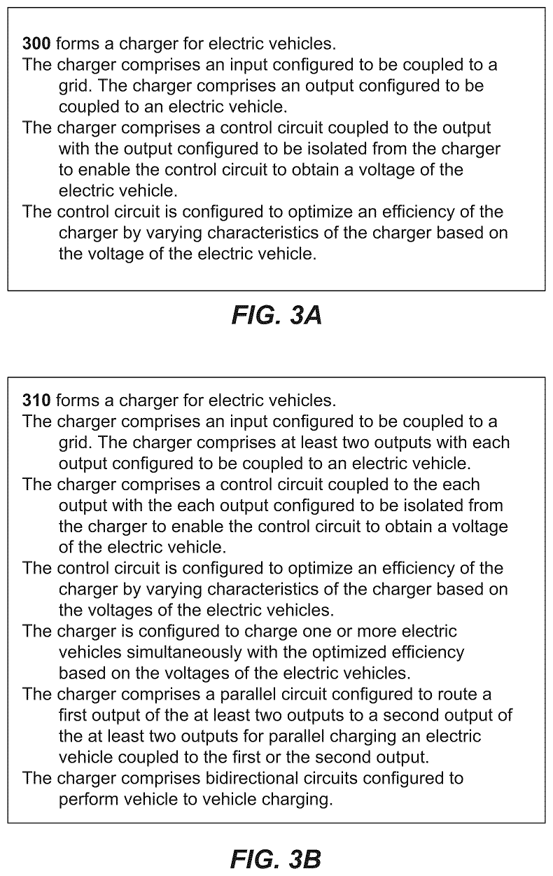

FIGS. 3A-3B illustrate flow charts for forming a charger according to some embodiments. In FIG. 3A, operation 300 forms a charger for electric vehicles.

The charger comprises an input configured to be coupled to a grid. The charger comprises an output configured to be coupled to an electric vehicle.

The charger comprises a control circuit coupled to the output with the output configured to be isolated from the charger to enable the control circuit to obtain a voltage of the electric vehicle.

The control circuit is configured to optimize an efficiency of the charger by varying characteristics of the charger based on the voltage of the electric vehicle.

In FIG. 3B, operation 310 forms a charger for electric vehicles. The charger comprises an input configured to be coupled to a grid. The charger comprises at least two outputs with each output configured to be coupled to an electric vehicle.

The charger comprises a control circuit coupled to the each output with the each output configured to be isolated from the charger to enable the control circuit to obtain a voltage of the electric vehicle.

The control circuit is configured to optimize an efficiency of the charger by varying characteristics of the charger based on the voltages of the electric vehicles.

The charger is configured to charge one or more electric vehicles simultaneously with the optimized efficiency based on the voltages of the electric vehicles.

The charger comprises a parallel circuit configured to route a first output of the at least two outputs to a second output of the at least two outputs for parallel charging an electric vehicle coupled to the first or the second output.

The charger comprises bidirectional circuits configured to perform vehicle to vehicle charging.

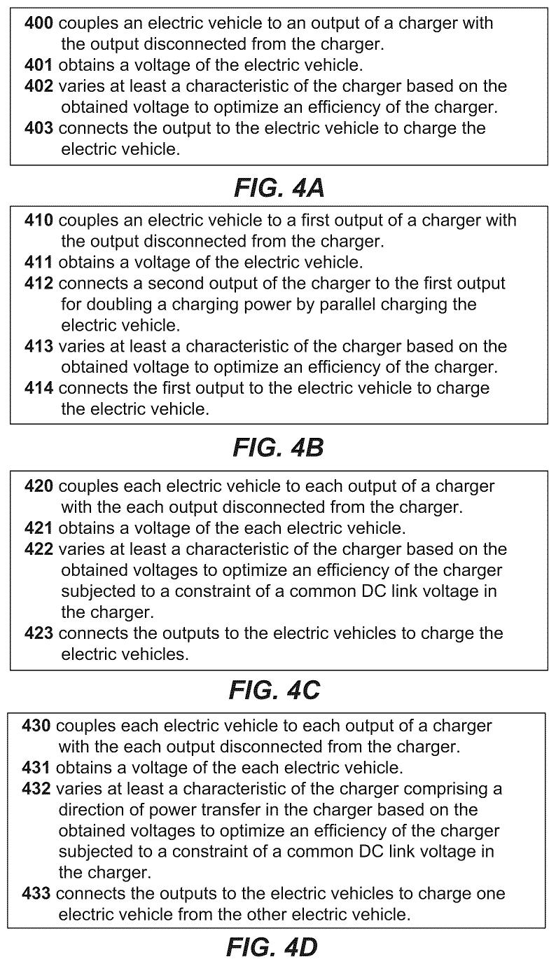

FIGS. 4A-4D illustrate flow charts for operating a charger according to some embodiments. In FIG. 4A, operation 400 couples an electric vehicle to an output of a charger with the output disconnected from the charger. Operation 401 obtains a voltage of the electric vehicle. Operation 402 varies at least a characteristic of the charger based on the obtained voltage to optimize an efficiency of the charger. Operation 403 connects the output to the electric vehicle to charge the electric vehicle.

In FIG. 4B, operation 410 couples an electric vehicle to a first output of a charger with the output disconnected from the charger. Operation 411 obtains a voltage of the electric vehicle. Operation 412 connects a second output of the charger to the first output for doubling a charging power by parallel charging the electric vehicle. Operation 413 varies at least a characteristic of the charger based on the obtained voltage to optimize an efficiency of the charger. Operation 414 connects the first output to the electric vehicle to charge the electric vehicle.

In FIG. 4C, operation 420 couples each electric vehicle to each output of a charger with the each output disconnected from the charger. Operation 421 obtains a voltage of the each electric vehicle. Operation 422 varies at least a characteristic of the charger based on the obtained voltages to optimize an efficiency of the charger subjected to a constraint of a common DC link voltage in the charger. Operation 423 connects the outputs to the electric vehicles to charge the electric vehicles.

In FIG. 4D, operation 430 couples each electric vehicle to each output of a charger with the each output disconnected from the charger. Operation 431 obtains a voltage of the each electric vehicle. Operation 432 varies at least a characteristic of the charger comprising a direction of power transfer in the charger based on the obtained voltages to optimize an efficiency of the charger subjected to a constraint of a common DC link voltage in the charger. Operation 433 connects the outputs to the electric vehicles to charge one electric vehicle from the other electric vehicle.

### Chargers for Charging Electric Vehicle Having a Wide Voltage Range

The power converter module can be configured to generate a wide range in DC voltage at a DC output terminal of the power converter module while maintaining a high efficiency. In addition, the power converter module can have a high power rating, such as a power rating of over 100 KW. The wide range of DC voltage at a DC output terminal of the power converter module is needed to charge different electric vehicles having a wide range, such as between 50 V and 1000 V. Thus, the power converter module can be used to charge a variety of types of electric vehicles, which provides for an economical solution for electric vehicle charging stations.

The power converter module includes an AC-DC converter, e.g., a rectifier stage, configured to provide an intermediate DC output voltage from an AC voltage from a grid. The power converter module also includes two DC-DC converters configured to condition the DC output voltage from the AC-DC converter to provide DC output voltages suitable for charging electric vehicles. The AC-DC converter can be configured to provide an intermediate DC output voltage in a defined range, which can be used as input to the DC-DC converter to be converted to a DC voltage suitable to charge the electric vehicles.

The DC-DC converter can include a DC-AC circuit, which can be a bridge circuit, connected to a transformer circuit, with the output of the transformer circuit connected to an AC-DC circuit, e.g., a rectifier circuit, to provide the conditioned DC voltage for the electric vehicles.

The transformer circuit can include a variable transformer having a set of primary windings connected to the DC-DC circuit, and a set of secondary windings connected to the AC-DC circuit. The transformer circuit also includes a transformer switch circuit, which is coupled to the primary windings, the secondary windings, or both primary and secondary windings. The transformer switch circuit is configured to change a turn ratio of the transformer by selectively integrating or excluding the winding portions of the set of primary or secondary windings.

The DC-DC converter can be a dual active bridge (DAB) having a primary side and a secondary side connected by a transformer. The primary side can include a DC-AC circuit having multiple switches forming multiple bridge arms. The secondary side can include an AC-DC circuit also having multiple switches forming bridge arms. A control circuit can be coupled to the DC-DC converter, for example, to change a ratio of the transformer or a switching characteristic of the switches in the primary or secondary side. The DAB can also be configured as a resonant converter. Other configurations can be used, such as a multi-level bridge converter, a cascaded converter, or a bridge type converter.

The control circuit can be configured to determine an operating mode for the DC-DC converter, with each operating mode having an appropriate ratio of the transformer, appropriate switching characteristics of the switches in the primary side, or appropriate switching characteristics of the switches in the secondary side.

By changing the operating modes of the primary side inverter and the secondary rectifier, the DC/DC converter may produce multiple ranges of voltage conversion ratios, and achieve a high efficiency voltage conversion when the AC/DC converter is operating in wide input and output voltage ranges.

The resonant converter topology, such as a DAB resonant converter, can be widely used as an isolated DC-DC converter, due to its high efficiency, simple structure achieved by magnetic integration, soft switching on both primary and secondary switches, and capability suitable for applications with wide voltage ranges. For example, a full-bridge DAB resonant converter under closed-loop voltage control can be used to provide a primary side full bridge output voltage, which can be regulated by controlling the switching frequency of these primary side switches. Highest efficiency is attained when the resonant converter operates at the resonant frequency, which is determined by a resonant inductor and a resonant capacitor in the resonant circuit, and when the DC voltage gain Vout/Vin equals to the transformer's turns ratio Nin/Nout.

The voltage gain is inversely proportional to the switching frequency. But the efficiency always reduced when the switching frequency deviates from resonant frequency. Thus, to achieve high efficiency, the resonant converter operates at an appropriate frequency range, e.g., at or near the resonant frequency.

By changing the turn ratio of the transformer, the voltage gain can vary to achieve a best performance of the DC-DC-converter at different operating voltages. Further, the voltage gain can be maintained substantially constant, preferably close to unity, for the achievable operating voltage ranges. This enables a switching frequency of the DC-DC converter to be close to the resonant frequency, thus, increasing the efficiency of the DC-DC converter. Further, a variation of the intermediate DC output voltage at the output of the AC-DC converter, e.g., at the input of the DC-DC converter, can allow flexibility in choosing the best operating point with regard to efficiency.

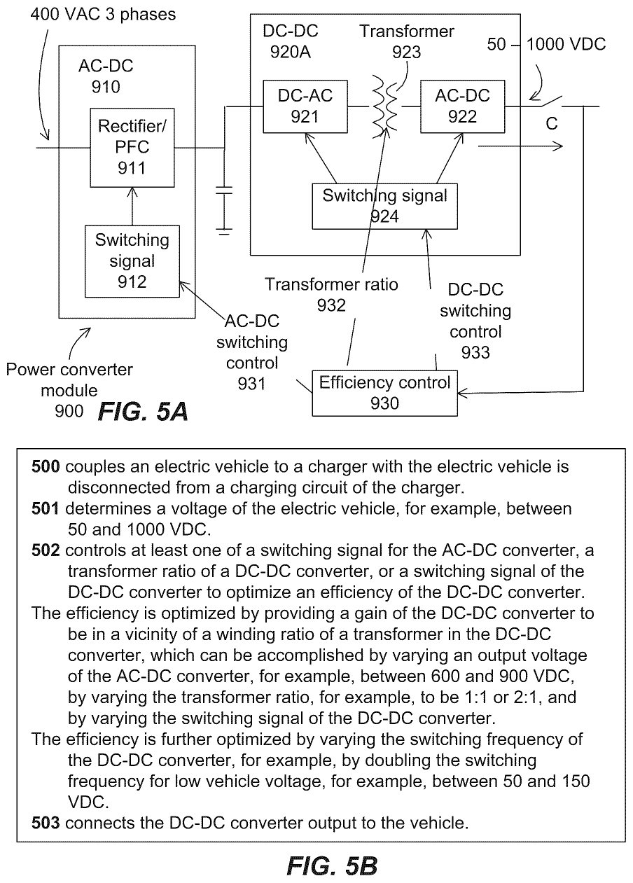

FIGS. 5A-5B illustrate a configuration for a charger capable of charging electric vehicles having a wide voltage range with high efficiency according to some embodiments. FIG. 5A shows a block diagram of a power converter module in a charger, with an efficiency control circuit 930 to regulate the characteristics of the power converter module to achieve a high power transfer efficiency for a wide output voltage range suitable to charge electric vehicles having different battery voltages.

The power converter module 900 includes an AC-DC converter 910 having an input configured to be coupled to an electrical distribution grid, and an intermediate DC output voltage coupled to an input of the DC-DC converter 920A with a DC link capacitor. The AC-DC converter 910 includes a rectifier and PFC circuit 911, which is controlled by a switching circuit 912. The rectifier and PFC circuit 911 can include multiple switches forming a full bridge configuration. The switching circuit 912 can be configured to generate switching signals having a switching frequency and duty cycle to control the switches in the rectifier and PFC circuit 911 to generate an intermediate DC output voltage within a defined range of DC voltage. The voltage value of the intermediate DC output is controlled by an AC-DC switching control 931 generated by the efficiency control circuit 930.

The DC-DC converter 920A can have a resonant topology, including a variable transformer 923. The variable transformer can have a primary side coupled to a DC-AC circuit 921, e.g., a circuit configured to convert the intermediate DC output voltage from the AC-DC converter 910 into an AC voltage, such as a square wave voltage through a multiple switch configuration. The variable transformer can have a secondary side coupled to an AC-DC circuit 922, e.g., a circuit configured to convert the AC output from the DC-AC circuit 921 into a DC voltage, through another multiple switch configuration. The DC-DC converter 920A can include a switching circuit 924 configured to generate switching signals having switching frequencies and duty cycles for the DC-AC circuit 921 and the AC-DC circuit 922, together with a phase shift between the DC-AC circuit 921 and the AC-DC circuit 922.

The efficiency control circuit 930 is also configured to generate a control signal 932 for changing a transformer ratio of the variable transformer 923. The efficiency control circuit 930 is also configured to generate DC-DC switching control signal 933, which is configured to control the switching circuit 924 to optimize the efficiency of the DC-DC converter 920A, based on the switching signals controlling the switching frequencies and duty cycles, and to control a power transfer flow direction of the DC-DC converter 920A, based on the switching signals controlling the phase shift.

FIG. 5B shows an operation of a charger capable of charging electric vehicles having a wide voltage range with high efficiency. The method includes the following operations, not necessarily in this order.

Operation 500 couples an electric vehicle to a charger with the electric vehicle is disconnected from a charging circuit of the charger, such as disconnecting from a DC-DC converter of the charger through a controllable switch turning off. Operation 501 determines a voltage of the electric vehicle, for example, between 50 and 1000 VDC.

Operation 502 controls at least one of a switching signal for an AC-DC converter, a transformer ratio of the DC-DC converter, or a switching signal of the DC-DC converter of the charger to optimize an efficiency of the DC-DC converter.

The efficiency is optimized by providing a gain of the DC-DC converter to be in a vicinity of a winding ratio of a transformer in the DC-DC converter, which can be accomplished by varying an output voltage of the AC-DC converter, for example, between 600 and 900 VDC, by varying the transformer ratio, for example, to be 1:1 or 2:1, and by varying the switching signal of the DC-DC converter.

For example, the transformer can have multiple winding portions connected to a switch circuit. The switch circuit is configured to change a turn ratio of the transformer by selectively integrating or excluding some winding portions from the conductive circuit, such as to form parallel or serial winding portions.

The efficiency is further optimized by varying the switching frequency of the DC-DC converter, for example, by doubling the switching frequency for low vehicle voltage, for example, between 50 and 150 VDC.

Operation 503 connects the DC-DC converter output to the vehicle. An input switch of the charger can be turned on to connect the charger, e.g., the AC-DC converter of the charger, a power source, such as a grid having an AC output voltage.

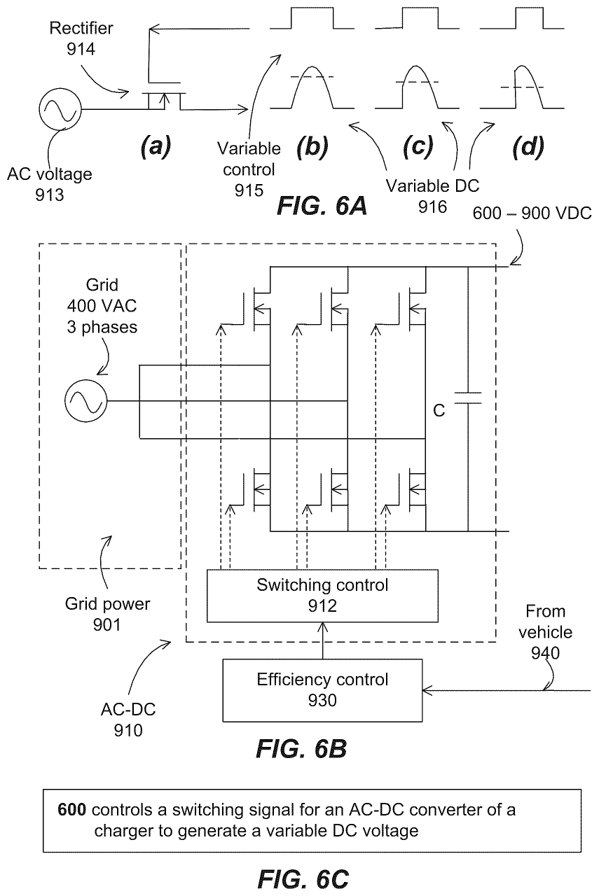

FIGS. 6A-6C illustrate an operation of an AC-DC converter having a variable output voltage according to some embodiments. FIG. 6A (a) shows a simple rectifier circuit 914 including a switch coupled to an AC voltage 913. The switch is controlled by a control signal 915 to provide a DC output voltage 916. By changing the control signal 915, such as changing a duty cycle, the DC output voltage 916 can include a full half wave (FIG. 6A (b)), a little less than the half wave (FIG. 6A (c)), and some more less than the half wave (FIG. 6A (d)), resulting in a variable DC output voltage.

FIG. 6B shows a configuration for an AC-DC converter 910. As shown, the AC-DC converter includes a 3 phase full bridge rectifier circuit, configured to be coupled to a grid power 901, such as to a 400 VAC, 3 phase grid. The AC-DC converter can include a DC link capacitor operated at a high-voltage of 600V-900V to reduce peak currents and therefore maximize efficiency and power density. Alternatively, the AC-DC converter can be a single phase unit. The three-phase option is more efficient and lighter than a single phase option. For high power chargers (>20 KW), the three-phase option would be the preferred option. At low powers, and where a three-phase feed is unavailable, the single-phase option would offer a viable alternative.

An AC-DC converter can be configured to achieve high power factor correction (99%), low total harmonic distortion (<7%), high efficiency, and high-power density, such as a three phase buck type AC-DC converter. Moreover, three phase buck type AC-DC converter provides inherent inrush current free startup, wider output voltage control range, phase leg shoot through protection, and overcurrent protection circuit during short circuit in comparison with boost type three-phase rectifier. In addition, input current can be controlled without closed-loop configurations.

A three phase buck type AC-DC converter can include three legs for coupling to the three phase of the input AC voltage, with each leg having two switches to form a full bridge rectifier. High switching frequency, such as 20 KHz-100 kHz, can be used to keep a low second harmonic distortion. Additional improvements can be added to the three phase buck type AC-DC converter, such as freewheeling diodes, two diode legs, or transfer matrix-based controller. Further, other AC-DC configurations can be used, such as a Swiss rectifier which offers higher efficiency, lower common-mode noise, lower conduction, and switching loss of the switches, three-phase Vienna rectifier using diodes which is unidirectional, three-phase bidirectional Vienna rectifier using switches, three-phase six switch boost rectifier which offers a simplified structure, continuous input current, bidirectional operation, high output dc voltage, low current stress, less number of switches, simple control scheme, low total harmonic distortion, and high efficiency, or ZVS enabled three-phase boost rectifier.

The AC-DC converter 910 can have an efficiency control circuit 930, which can generate control signals to the switching control circuit 912, based on the battery voltage of the electric vehicle.

FIG. 6C shows an operation of an AC-DC converter having a variable output voltage. Operation 600 controls a switching signal for an AC-DC converter of a charger to generate a variable DC voltage.

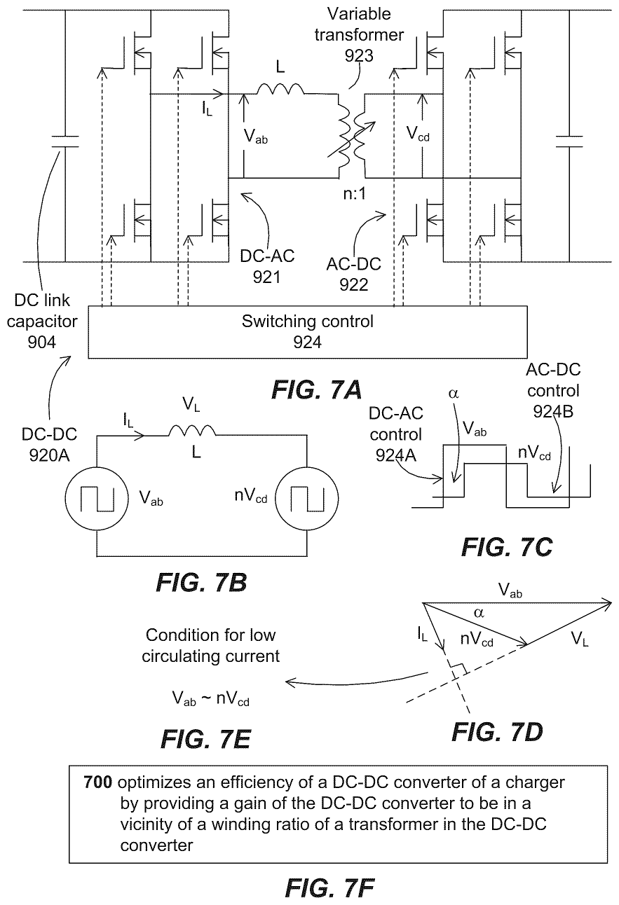

FIGS. 7A-7F illustrate an operation of a DC-DC converter having an optimum efficiency according to some embodiments. FIG. 7A shows a configuration for a DC-DC converter 920A. Since the battery of the electric vehicle should be floating with respect to the ground, galvanic isolation is required to maintain the isolation between the grid and the battery. This can be achieved by using an isolated DC/DC converter, such as a dual active bridge (DAB), which can have high power density, high efficiency, buck and boost capability, low device stress, small filter components, and low sensitivity to component variation.

The DC-DC converter includes two full-bridges 921 and 922, an isolation transformer having a variable winding ratio of n:1, and an external leakage inductance L on the primary side that enables zero voltage switching (ZVS). The single transformer architecture in the DC-DC converter facilitates bidirectional operation. Furthermore, the symmetry of the converter with the transformer helps maximize the operating range where ZVS of the power switches is achieved to enable a high efficiency. The DC-DC converter can operate at 20 kHz-100 kHz, to keep the switching losses at a reasonable level as well as the core and ac losses of the magnetic components.

The DC-DC converter is coupled to a DC link capacitor 904 which is coupled to an AC-DC converter. In the DAB converter, the power flow is controlled by adjusting the phase shift between primary and secondary voltage, with transformer leakage inductance L serving as the power transfer element. The DC-DC converter can include a switching control 924 to generate switching signals for the switches in the full bridges 921 and 922, such as to control a phase shift between the two bridges to determine a power flow, and control a switching frequency or a duty cycle of the switches.

There is a trade off in wide range of voltage gain and efficiency of a DAB DC-DC converter. A wide range of voltage gain can significantly increase the reactive power and invalidate the condition of zero voltage switching (ZVS), a condition in which the transistor voltage is constrained close to zero when the transistor switches on or off, resulting in lower efficiency. Thus, a variable transformer can ease the design of the converter by using the different ratios of the transformer to assist in enlarging the voltage gain.

FIG. 7B shows simplified equivalent circuit of a DAB converter assuming ideal power semiconductor devices and transformer, including the inductor L disposed between two square wave signals at the primary side and the secondary side of the transformer. The output voltage and power of a DAB converter can be regulated by shifting phases of the square voltage generated by bridges, such as Vab and nVcd. A simple modulation scheme is the single phase shift modulation, in which Vab and Vcd have a constant 50% duty cycle with their phase difference is controlled to regulate the output voltage. FIG. 7C shows the phase shift between the two square wave signals.

When a DAB converter is modulated using a single phase modulation, the current IL through the inductor L involves a portion of a reactive current. Similar to the reactive current in an AC grid, the reactive current does not transfer any energy, but produces conduction losses and transformer losses. The amount of reactive current is closely related to voltage gain M=nVcd/Vab, which can be explained by the phasor diagram in FIGS. 7D and 7E. For a given phase shift, a high percentage of reactive power occurs when the voltage gain is different from 1.

FIG. 7F shows an operation of a DC-DC converter having an optimum efficiency. Operation 700 optimizes an efficiency of a DC-DC converter of a charger by providing a gain of the DC-DC converter to be in a vicinity of a winding ratio of a transformer in the DC-DC converter.

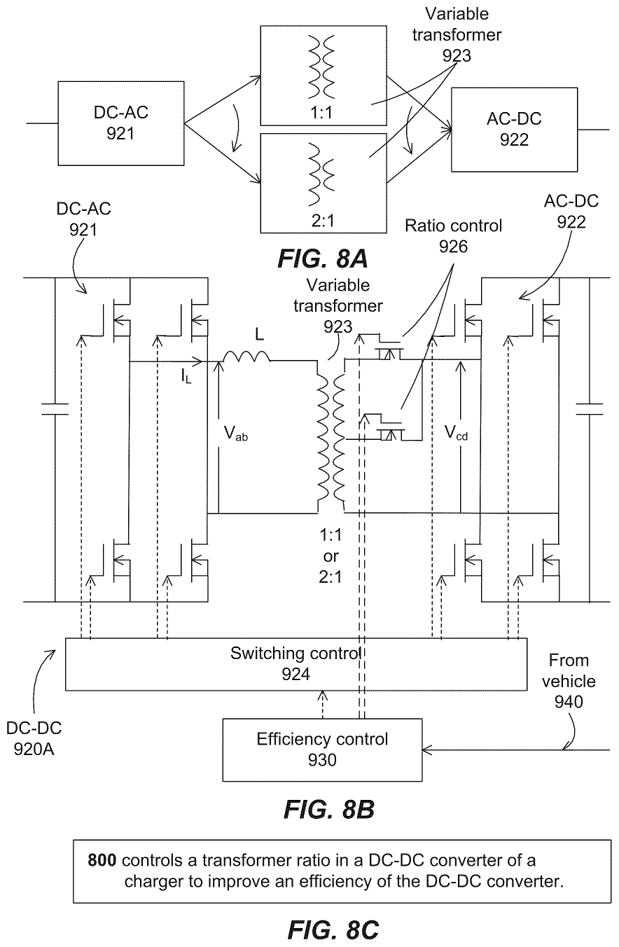

FIGS. 8A-8C illustrate an operation of a DC-DC converter having a variable transformer according to some embodiments. For cost effectiveness, the variable transformer can include a multiple ratio transformer, formed by multiple winding portions arranged in parallel or in serial configurations, for example, to achieve a 1:1 ratio and a 2:1 ratio.

FIG. 8A shows a schematic of a DC-DC converter having two bridge portions 921 and 922 connected by a variable transformer 923 having ratios of 1:1 and 2:1. FIG. 8B shows a circuit schematic for a DC-DC converter 920A, including a DC-AC bridge 921 and an AC-DC bridge 922 coupled to a variable transformer 923. The bridge circuit may be a full bridge circuit with a first bridge branch and a second bridge branch in parallel with each other. Each bridge branch can include 2 switches in series, such as a pair of MOSFETs.

A ratio control circuit 926 including switches is coupled to the winding portions of the transformer 923, in order to change the winding ratio of the transformer. For example, when the top switch is turned on and the bottom switch is turned off, the transformer is configured to have a winding ratio of 1:1. When the top switch is turned off and the bottom switch is turned on, the transformer is configured to have a winding ratio of 2:1.

As shown, the turn ratio of the transformer is changed by changing the number of turns of the secondary winding. Alternatively, the turn ratio of the transformer can be changed by changing the number of turns of the primary winding.

A switching control circuit 924 is included to generate switching signals to control the switches in the two bridge portions 921 and 922. An efficiency control circuit 930 is also included, which can be configured to control the switching control circuit 924 and the ratio control circuit 926, based on the battery voltage 940 of the electric vehicle.

FIG. 8C shows an operation of a DC-DC converter having a variable transformer. Operation 800 controls a transformer ratio in a DC-DC converter of a charger to improve an efficiency of the DC-DC converter.

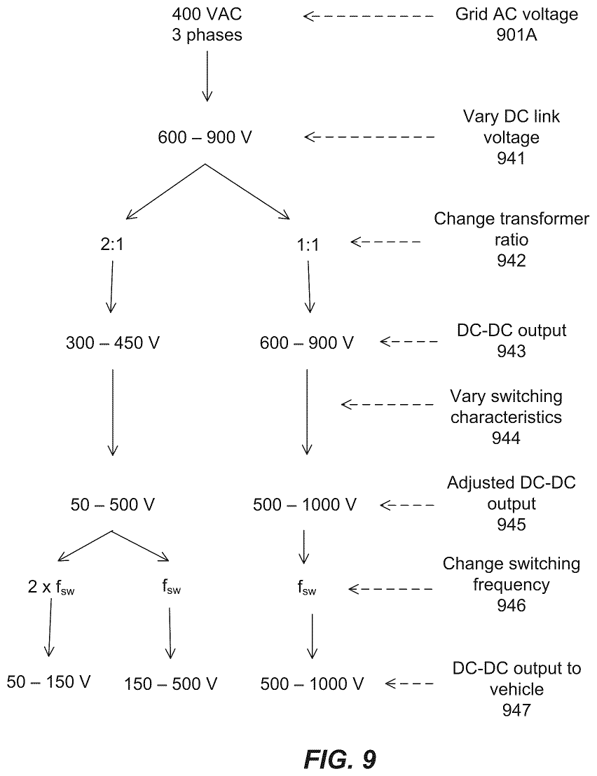

FIG. 9 illustrates an operation of a charger having a wide output voltage range with high efficiency according to some embodiments. The charger is configured to be coupled to a grid voltage 901A, such as 400 VAC, 3 phases. A controller in the charger then varies 941 the DC link voltage, e.g., changing the switching signals for the AC-DC converter to be between 600V and 900V, for example. The controller then changes 942 the transformer ratio to be either 1:1 or 2:1, resulting in an output voltage 943 of the DC-DC converter to be either 600V-900V or 300V-450V. The controller can optionally change 945 the characteristics of the switching signals for the DC-DC converter to further adjust the output voltage of the DC-DC converter, for example, to be 500V-1000V or 50V-500V. The controller then doubles 946 the switching frequency of the DC-DC converter for the DC output voltage range of 50V-150V. As such, the charger can be able to provide a DC output in the range of 50V-1000V with high performance.

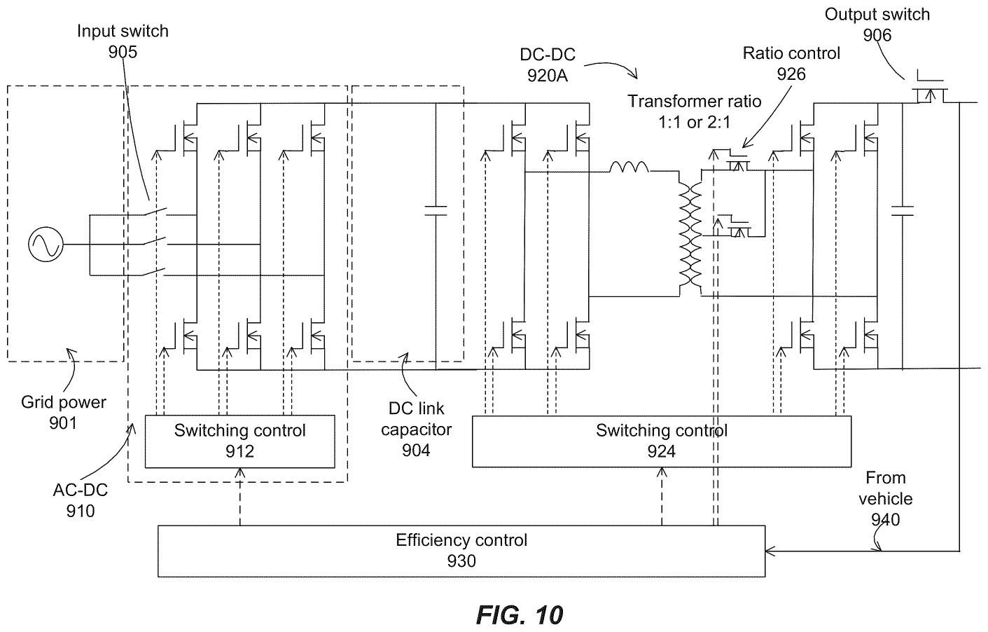

FIG. 10 illustrates a schematic of a charger having a wide output voltage range with high efficiency according to some embodiments. The power converter module of the charger can have few stages, e.g., an AC-DC converter 910 and a DC-DC converter 920A coupled with a DC link capacitor 904, with an input of the AC-DC converter is configured to be coupled to a grid 901 through input switches 905, and an output of the DC-DC converter is configured to be coupled to an electric vehicle through an output switch 906.

The DC-DC converter also includes a variable ratio transformer, controlled by a ratio control circuit 926 having multiple switches. Switching control circuits 912 and 924 are configured to generate switching signals to control the switches of the AC-DC and DC-DC converters. An efficiency control circuit 930, which can be a controller, is used to control the turn ratio of the transformer through the ratio control circuit 926, and the characteristics of the switches in the AC-DC and DC-DC converters, based on a signal 940 from the electric vehicle, such as a measured voltage of the battery in the electric vehicle.

A combination of fewer stages and high efficiency high voltage power electronics results in an overall higher system efficiency in the order of 95-98%.

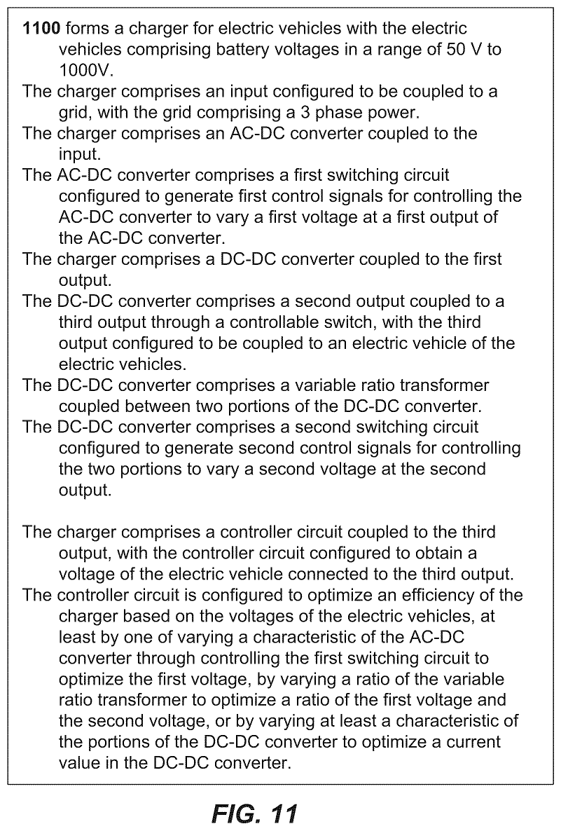

FIG. 11 illustrates a flow chart for forming a charger having a wide output voltage range with high efficiency according to some embodiments. Operation 1100 forms a charger for electric vehicles with the electric vehicles comprising battery voltages in a range of 50 V to 1000V. The charger comprises an input configured to be coupled to a grid, with the grid comprising a 3 phase power.

The charger comprises an AC-DC converter coupled to the input. The AC-DC converter comprises a first switching circuit configured to generate first control signals for controlling the AC-DC converter to vary a first voltage at a first output of the AC-DC converter.

The charger comprises a DC-DC converter coupled to the first output. The DC-DC converter comprises a second output coupled to a third output through a controllable switch, with the third output configured to be coupled to an electric vehicle of the electric vehicles. The DC-DC converter comprises a variable ratio transformer coupled between two portions of the DC-DC converter. The DC-DC converter comprises a second switching circuit configured to generate second control signals for controlling the two portions to vary a second voltage at the second output.

The charger comprises a controller circuit coupled to the third output, with the controller circuit configured to obtain a voltage of the electric vehicle connected to the third output. The controller circuit is configured to optimize an efficiency of the charger based on the voltages of the electric vehicles, at least by one of varying a characteristic of the AC-DC converter through controlling the first switching circuit to optimize the first voltage, by varying a ratio of the variable ratio transformer to optimize a ratio of the first voltage and the second voltage, or by varying at least a characteristic of the portions of the DC-DC converter to optimize a current value in the DC-DC converter.

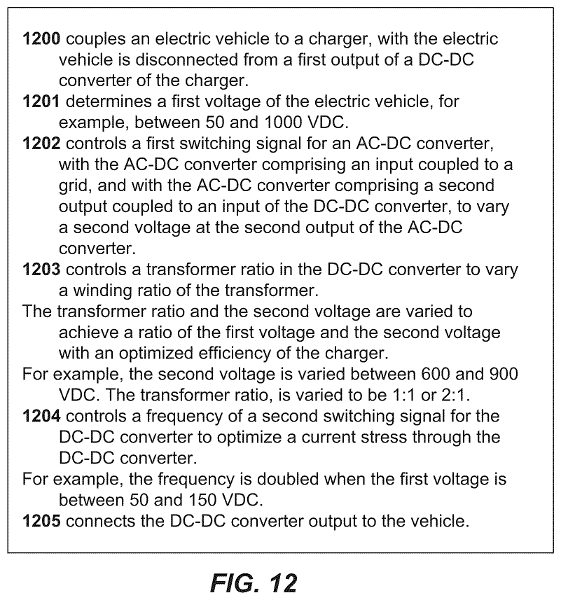

FIG. 12 illustrates a flow chart for operating a charger having a wide output voltage range with high efficiency according to some embodiments. Operation 1200 couples an electric vehicle to a charger, with the electric vehicle is disconnected from a first output of a DC-DC converter of the charger. Operation 1201 determines a first voltage of the electric vehicle, for example, between 50 and 1000 VDC. Operation 1202 controls a first switching signal for an AC-DC converter, with the AC-DC converter comprising an input coupled to a grid, and with the AC-DC converter comprising a second output coupled to an input of the DC-DC converter, to vary a second voltage at the second output of the AC-DC converter.

Operation 1203 controls a transformer ratio in the DC-DC converter to vary a winding ratio of the transformer. The transformer ratio and the second voltage are varied to achieve a ratio of the first voltage and the second voltage with an optimized efficiency of the charger. For example, the second voltage is varied between 600 and 900 VDC. The transformer ratio, is varied to be 1:1 or 2:1.

Operation 1204 controls a frequency of a second switching signal for the DC-DC converter to optimize a current stress through the DC-DC converter. For example, the frequency is doubled when the first voltage is between 50 and 150 VDC.

Operation 1205 connects the DC-DC converter output to the vehicle.

### Chargers for Charging Multiple Electric Vehicles Each Having a Wide Voltage Range

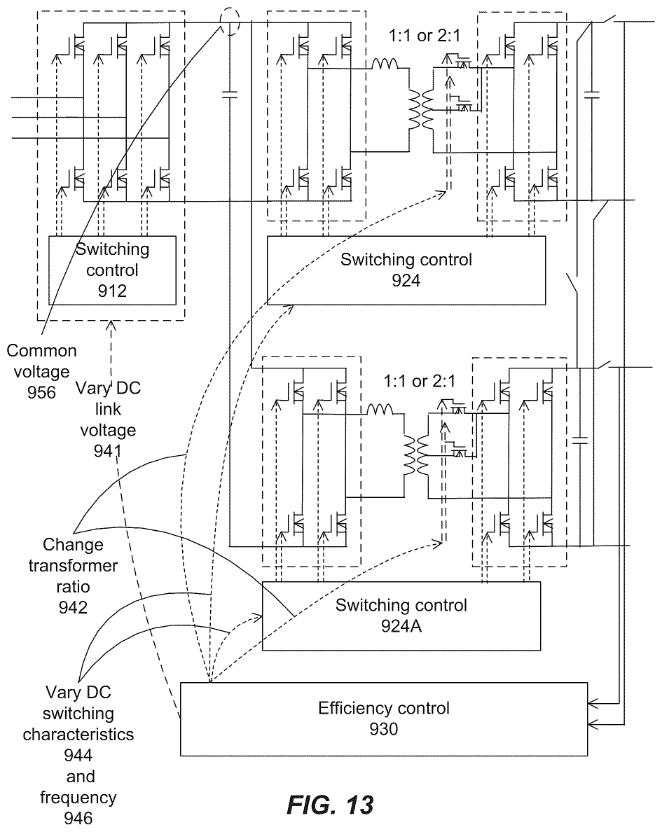

FIG. 13 illustrates a schematic of a charger having two outputs according to some embodiments. A charger, e.g., a power converter module, can include one AC-DC converter coupled to two DC-DC converters with a DC link capacitor disposed in between, for example, to reduce harmonic distortion. The outputs of the DC-DC converters can be coupled together by a circuit configured to connect the outputs together for parallel charging an electric vehicle. Each DC-DC converter can include a transformer having multiple arrangeable windings, which can be arranged to provide a transformer having multiple turn ratios. In a trade off of efficiency, two turn ratios can be used to provide two different ranges of output voltage with two controllable switches for selecting between the turn ratios. The outputs of the DC-DC converters each can be coupled to a controllable switch, to allow an isolation of the electric vehicles from the charger circuitry. The inputs of the charger can be coupled to controllable switches, to isolate the charger from the grid power.

The charger can include a controller, such as an efficiency control circuit 930, which is configured to maximize performance and efficiency of the charger based on the battery voltages measured from the electric vehicles coupled to the charger. The battery voltages can be measured after the electric vehicles are coupled to the charger with the controllable switch connecting the outputs of the DC-DC converters to the outputs of the charger disconnected.

For example, after obtaining the voltages of the electric vehicles, the controller can provide ratio control signals 942 to the transformer control circuits, such as the switches connecting different windings of the transformers, to form the transformers having turn ratios suitable for the electric vehicles. For example, if the voltages of the electric vehicles are in the range of 500V-1000V, the turn ratio of the transformers is set to 1:1. If the voltages of the electric vehicles are in the range of 50V-500V, the turn ratio of the transformers is set to 5:1.

After setting the transformer turn ratios, the output voltage of the AC-DC converter is adjusted to provide a voltage gain of the DC-DC converters to be close to unity, for example, by the controller providing AC-DC control signals 941 to the switching control circuit 912 controlling the switches of the AC-DC converter. For example, if the voltages of the electric vehicles are 800V or 400V, the switching control circuit 912 can be controlled so that the output of the AC-DC converter is 800V. With the transformer ratios at to either 1:1 or 2:1, the voltage gain of the DC-DC converters is unity. In practice, the battery voltages of the electric vehicles can slightly vary, based on the state of charge of the battery. Further, the charger can have a charging strategy suitable for the electric vehicles, thus the output voltages of the charger can also vary to be in a vicinity of the battery voltages.

The controller can also provide control signals 944 or 946 to the switching control circuits of the DC-DC converters, for example, to change a characteristic of the DC-DC converters for achieving a better efficiency or performance. For example, if the voltages of the electric vehicles are between 50V and 150V, there is a significant deviation of the voltage gain from unity, e.g., larger than 2× deviation. Since the electric vehicles having a battery voltage range of 50V-150V are not popular, e.g., there are fewer electric vehicles having this voltage range, as compared to other voltage ranges, the charger is designed to provide a lower efficiency for the electric vehicles having this battery voltage range, in order to simplify the charger configuration, which can lead to better efficiency at other voltage ranges.

The charger can be configured to change a switching frequency of the switches in the DC-DC converters to reduce a current stress. For example, the switching frequency can be doubled, which can reduce the current stress by a factor of two without much effect on the efficiency.

In addition, the charger can optionally provide advanced switching methodologies to the switches in the DC-DC converters, such as changing the phase shift or duty cycles to improve the efficiency.

The efficiency of the charger having two DC-DC converters for simultaneously charging two electric vehicles can be determined differently from the efficiency determination of the charger having only one DC-DC converter, due to a constraint of a common voltage 956 at the output of the AC-DC converter, which is also the input for both DC-DC converters.

In one efficiency determination strategy, the individual efficiencies of the DC-DC converters can be determined separately, resulting in two different input voltages for the DC-DC converters. The common voltage 956 can be determined as a value between two input voltages, based on an optimization of the total efficiency. The determination of the common voltage can be an iteration process, for example, by determine a total efficiency for each of the two input voltages and for a middle value of the two input voltages. A new range of input voltages is obtained from the middle value and an edge value of the two input voltages. The iteration process is continued until an optimized efficiency is obtained.

In another efficiency determination strategy, the transformer ratios can be set for overlapped ranges of battery voltages, such as 50V-600V and 400V-1000V. The overlapped ranges can be used when the two battery voltages are on opposite sides of 500V, such as 450V and 550V. Using different transformer ratios would provide a large variation of the input voltages for the DC-DC converters.

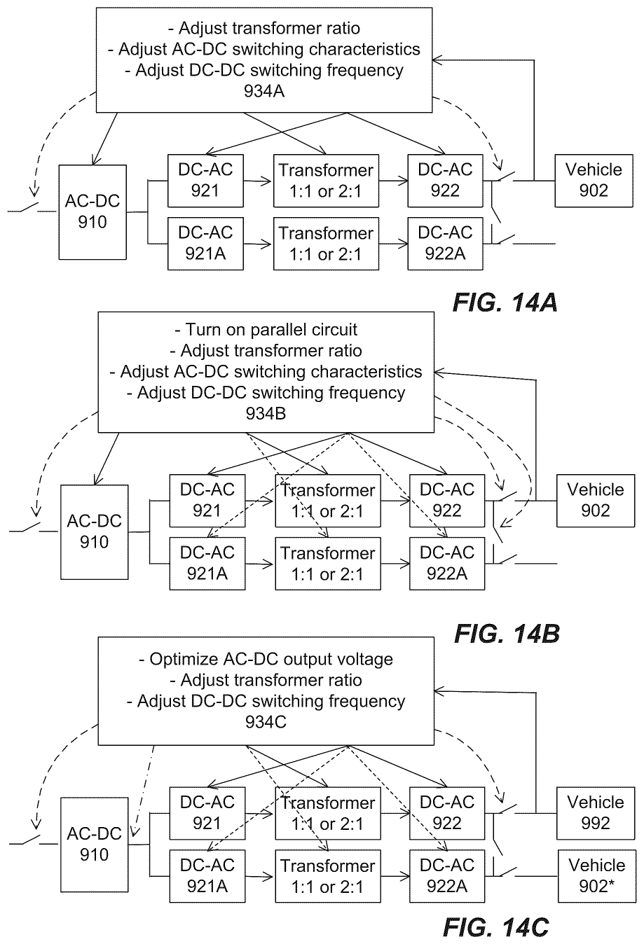

FIGS. 14A-14C illustrate operating configurations for a charger having two outputs for charging one or two electric vehicles according to some embodiments. A charger included an AC-DC converter 910, coupled to two DC-DC converters having a variable ratio transformer with a DC-AC portion 921 at a primary side and an AC-DC portion 922 at a secondary side. The input of the AC-DC converter is coupled to a grid through a controllable switch to allow disconnecting from the grid. The outputs of the DC-DC converters each coupled to an output of the charger through a controllable switch to allow disconnecting from the electric vehicle 902.

FIG. 14A shows a configuration for the charger to charge a single electric vehicle coupled to an output of the charger. A controller can send signals 934A to the controllable switches to disconnect the switches, for example, to measure a battery voltage of the electric vehicle 902. The control signals can include a signal to adjust the transformer ratio of the DC-DC converter that the electric vehicle is connected to. The control signals can include a signal to adjust the switching characteristics of the AC-DC converter to optimize an efficiency of the DC-DC converter, such as to achieve a unity gain for the DC-DC converter. The control signals can include a signal to adjust the switching frequency of the DC-DC converter to reduce a current stress in the DC-DC converter, such as when the voltage measured from the electric vehicle is in a range of 50V-150V. Other optimization schemes can also be used, such as changing a phase shift modulation instead of the single phase shift modulation. The controller then can send signals to the controllable switches to connect the switches to start charging.

FIG. 14B shows a configuration for the charger to charge a single electric vehicle coupled to an output of the charger using a full power of the charger, e.g., using the power from both DC-DC converters. A controller can send signals 934B to the controllable switches to disconnect the switches, for example, to measure a battery voltage of the electric vehicle 902. The control signals can include a signal to turn on the parallel circuit, such as turning on the switch connecting the outputs of the DC-DC converters. The control signals can include a signal to adjust the transformer ratios of both DC-DC converters. The control signals can include a signal to adjust the switching characteristics of the AC-DC converter to optimize an efficiency of the DC-DC converters, such as to achieve a unity gain for the DC-DC converters. The control signals can include a signal to adjust the switching frequency of the DC-DC converters to reduce a current stress in the DC-DC converters, such as when the voltage measured from the electric vehicle is in a range of 50V-150V. Other optimization schemes can also be used, such as changing a phase shift modulation instead of the single phase shift modulation. The controller then can send signals to the controllable switches to connect the switches to start charging.

FIG. 14C shows a configuration for the charger to simultaneously charge two electric vehicles coupled to two outputs of the charger. A controller can send signals 934B to the controllable switches to disconnect the switches, for example, to measure a battery voltage of the electric vehicle 902.

The controller can determine an optimized common voltage at the output of the AC-DC converter, e.g., the common input voltage to both DC-DC converters to achieve a maximum total efficiency, e.g., an efficiency for the charger. The determination of a common voltage can be an iteration process, based on the determination of maximum efficiency of individual DC-DC converters. For example, the conditions for the maximum efficiency of both DC-DC converters can be determined based on the battery voltages of the electric vehicles, including determining the transformer ratio and the output voltage of the AC-DC converter (which is also the input voltage for each DC-DC converter). An optimization process can be performed to determine the common voltage of the AC-DC output in the range of two values of the AC-DC output voltages determined from the maximum efficiency of the two DC-DC converters. The controller then sends signals 934C to the transformer and the AC-DC converter to set the transformer ratio and the voltage gain of the AC-DC converter, respectively.

In addition, the control signals can include a signal to adjust the switching frequency of the DC-DC converters to reduce a current stress in the DC-DC converters, such as when the voltage measured from the electric vehicle is in a range of 50V-150V.

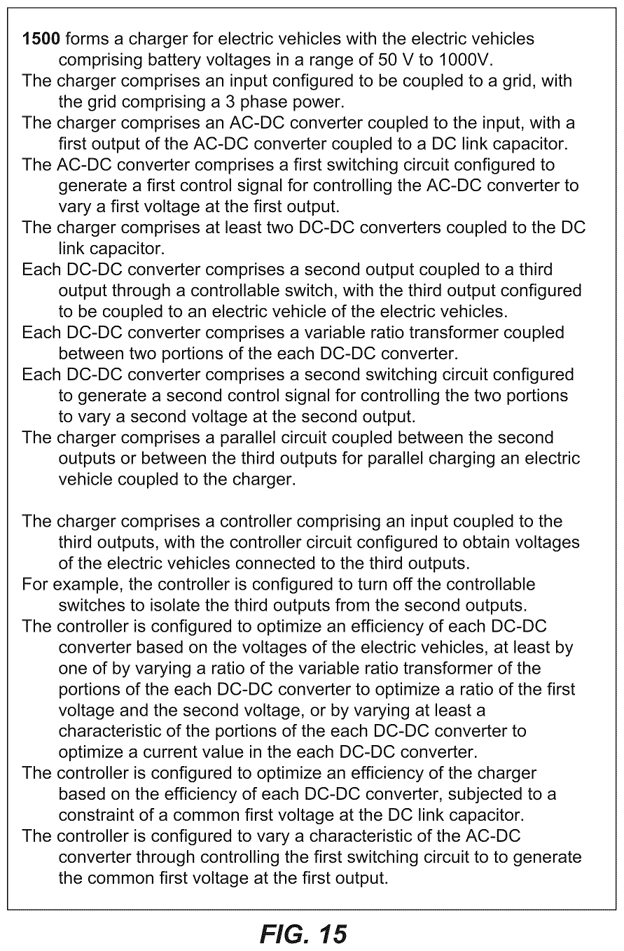

FIG. 15 illustrates a flow chart for forming a charger having two outputs according to some embodiments. Operation 1500 forms a charger for electric vehicles with the electric vehicles comprising battery voltages in a range of 50 V to 1000V. The charger comprises an input configured to be coupled to a grid, with the grid comprising a 3 phase power. The charger comprises an AC-DC converter coupled to the input, with a first output of the AC-DC converter coupled to a DC link capacitor. The AC-DC converter comprises a first switching circuit configured to generate a first control signal for controlling the AC-DC converter to vary a first voltage at the first output.

The charger comprises at least two DC-DC converters coupled to the DC link capacitor. Each DC-DC converter comprises a second output coupled to a third output through a controllable switch, with the third output configured to be coupled to an electric vehicle of the electric vehicles. Each DC-DC converter comprises a variable ratio transformer coupled between two portions of the each DC-DC converter. Each DC-DC converter comprises a second switching circuit configured to generate a second control signal for controlling the two portions to vary a second voltage at the second output. The charger comprises a parallel circuit coupled between the second outputs or between the third outputs for parallel charging an electric vehicle coupled to the charger.

The charger comprises a controller comprising an input coupled to the third outputs, with the controller circuit configured to obtain voltages of the electric vehicles connected to the third outputs. For example, the controller is configured to turn off the controllable switches to isolate the third outputs from the second outputs.

The controller is configured to optimize an efficiency of each DC-DC converter based on the voltages of the electric vehicles, at least by one of by varying a ratio of the variable ratio transformer of the portions of the each DC-DC converter to optimize a ratio of the first voltage and the second voltage, or by varying at least a characteristic of the portions of the each DC-DC converter to optimize a current value in the each DC-DC converter.

The controller is configured to optimize an efficiency of the charger based on the efficiency of each DC-DC converter, subjected to a constraint of a common first voltage at the DC link capacitor.

The controller is configured to vary a characteristic of the AC-DC converter through controlling the first switching circuit to generate the common first voltage at the first output.

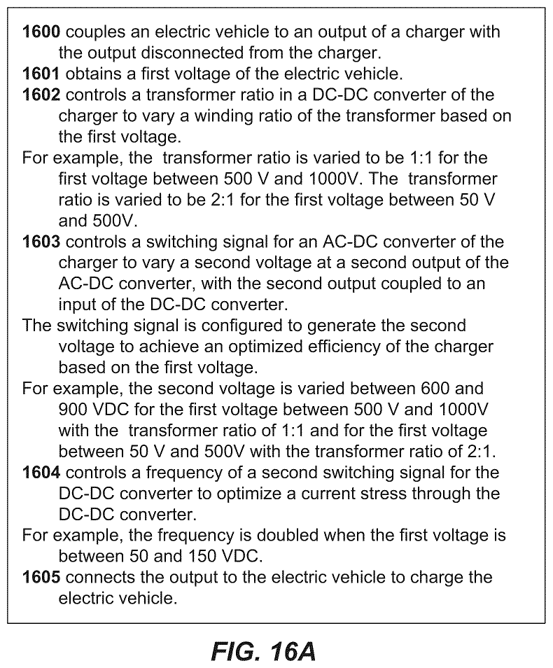

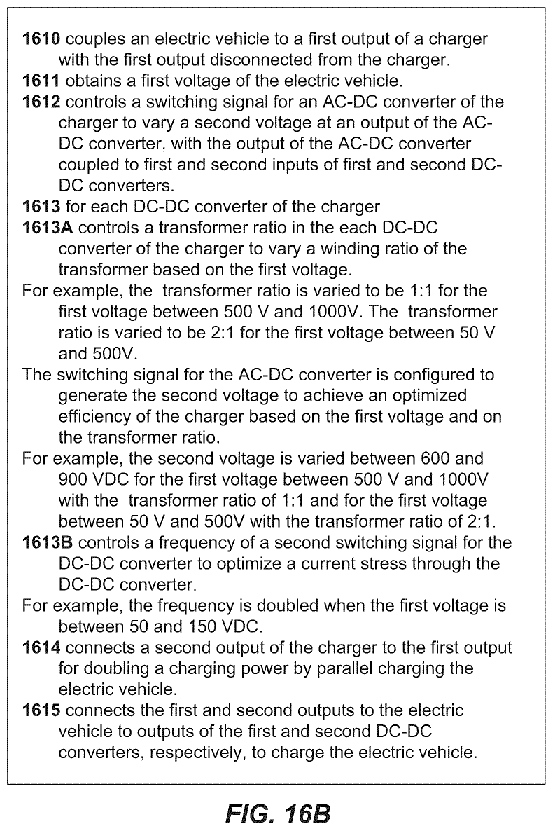

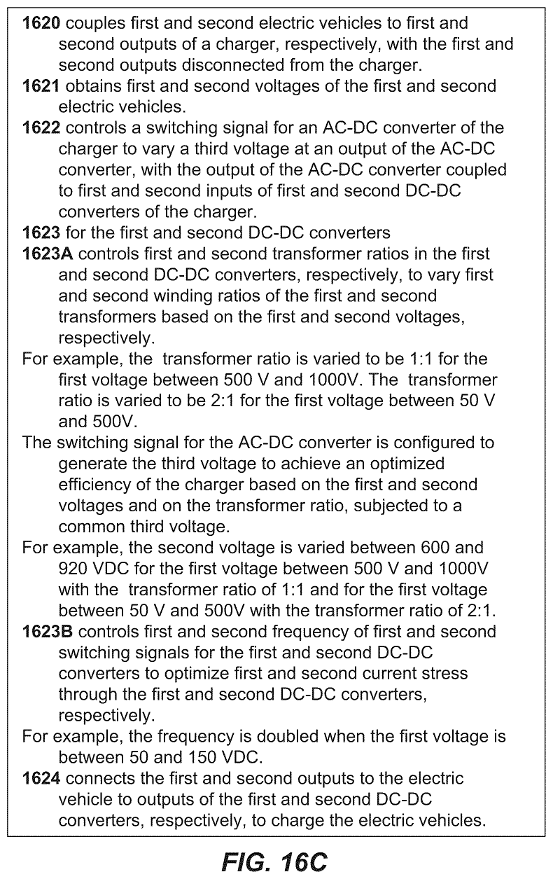

FIGS. 16A-16C illustrate flow charts for operating a charger having two outputs for charging two electric vehicles according to some embodiments. In FIG. 16A, operation 1600 couples an electric vehicle to an output of a charger with the output disconnected from the charger. Operation 1601 obtains a first voltage of the electric vehicle. Operation 1602 controls a transformer ratio in a DC-DC converter of the charger to vary a winding ratio of the transformer based on the first voltage. For example, the transformer ratio is varied to be 1:1 for the first voltage between 500 V and 1000V. The transformer ratio is varied to be 2:1 for the first voltage between 50 V and 500V.

Operation 1603 controls a switching signal for an AC-DC converter of the charger to vary a second voltage at a second output of the AC-DC converter, with the second output coupled to an input of the DC-DC converter. The switching signal is configured to generate the second voltage to achieve an optimized efficiency of the charger based on the first voltage. For example, the second voltage is varied between 600 and 900 VDC for the first voltage between 500 V and 1000V with the transformer ratio of 1:1 and for the first voltage between 50 V and 500V with the transformer ratio of 2:1.

Operation 1604 controls a frequency of a second switching signal for the DC-DC converter to optimize a current stress through the DC-DC converter. For example, the frequency is doubled when the first voltage is between 50 and 150 VDC.

Operation 1605 connects the output to the electric vehicle to charge the electric vehicle.

In FIG. 16B, operation 1610 couples an electric vehicle to a first output of a charger with the first output disconnected from the charger. Operation 1611 obtains a first voltage of the electric vehicle. Operation 1612 controls a switching signal for an AC-DC converter of the charger to vary a second voltage at an output of the AC-DC converter, with the output of the AC-DC converter coupled to first and second inputs of first and second DC-DC converters.

Operation 1613 configures each DC-DC converter of the charger. Operation 1613A controls a transformer ratio in the each DC-DC converter of the charger to vary a winding ratio of the transformer based on the first voltage. For example, the transformer ratio is varied to be 1:1 for the first voltage between 500 V and 1000V. The transformer ratio is varied to be 2:1 for the first voltage between 50 V and 500V. The switching signal for the AC-DC converter is configured to generate the second voltage to achieve an optimized efficiency of the charger based on the first voltage and on the transformer ratio. For example, the second voltage is varied between 600 and 900 VDC for the first voltage between 500 V and 1000V with the transformer ratio of 1:1 and for the first voltage between 50 V and 500V with the transformer ratio of 2:1.

Operation 1613B controls a frequency of a second switching signal for the DC-DC converter to optimize a current stress through the DC-DC converter. For example, the frequency is doubled when the first voltage is between 50 and 150 VDC.

Operation 1614 connects a second output of the charger to the first output for doubling a charging power by parallel charging the electric vehicle.

Operation 1615 connects the first and second outputs to the electric vehicle to outputs of the first and second DC-DC converters, respectively, to charge the electric vehicle.

In FIG. 16C, operation 1620 couples first and second electric vehicles to first and second outputs of a charger, respectively, with the first and second outputs disconnected from the charger. Operation 1621 obtains first and second voltages of the first and second electric vehicles.

Operation 1622 controls a switching signal for an AC-DC converter of the charger to vary a third voltage at an output of the AC-DC converter, with the output of the AC-DC converter coupled to first and second inputs of first and second DC-DC converters of the charger. Operation 1623 for the first and second DC-DC converters.

Operation 1623A controls first and second transformer ratios in the first and second DC-DC converters, respectively, to vary first and second winding ratios of the first and second transformers based on the first and second voltages, respectively. For example, the transformer ratio is varied to be 1:1 for the first voltage between 500 V and 1000V. The transformer ratio is varied to be 2:1 for the first voltage between 50 V and 500V. The switching signal for the AC-DC converter is configured to generate the third voltage to achieve an optimized efficiency of the charger based on the first and second voltages and on the transformer ratio, subjected to a common third voltage. For example, the second voltage is varied between 600 and 900 VDC for the first voltage between 500 V and 1000V with the transformer ratio of 1:1 and for the first voltage between 50 V and 500V with the transformer ratio of 2:1.

Operation 1623B controls first and second frequency of first and second switching signals for the first and second DC-DC converters to optimize first and second current stress through the first and second DC-DC converters, respectively. For example, the frequency is doubled when the first voltage is between 50 and 150 VDC.

Operation 1624 connects the first and second outputs to the electric vehicle to outputs of the first and second DC-DC converters, respectively, to charge the electric vehicles.

### Chargers for Vehicle-to-Vehicle Charging

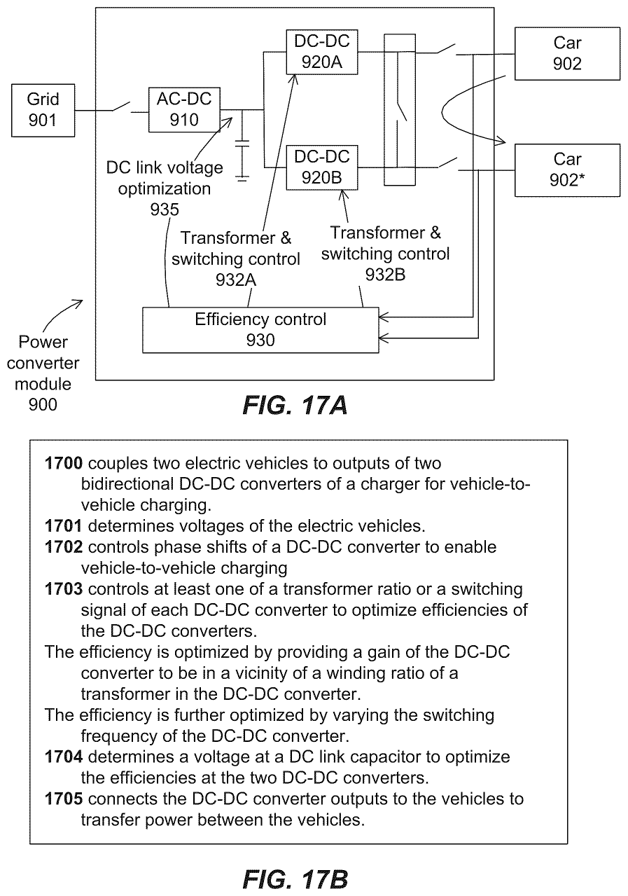

FIGS. 17A-17B illustrate a configuration for a charger capable of vehicle-to-vehicle charging according to some embodiments. FIG. 17A shows a block diagram of a power converter module in a charger, with an efficiency control circuit 930 to regulate the characteristics of the power converter module to achieve a high power transfer efficiency for a wide output voltage range suitable for coupling with electric vehicles having different battery voltages.

The power converter module 900 includes an AC-DC converter 910 having an input configured to be coupled to an electrical distribution grid 901, and a common DC output voltage coupled to inputs of two DC-DC converters 920A and 920B with a DC link capacitor. The AC-DC converter 910 includes a rectifier and PFC circuit, which is controlled by a switching circuit. The rectifier and PFC circuit can include multiple switches forming a full bridge configuration. The switching circuit can be configured to generate switching signals having a switching frequency and duty cycle to control the switches in the rectifier and PFC circuit to generate a common DC output voltage within a defined range of DC voltage. The voltage value of the common DC output is controlled by a DC link voltage optimization 935 generated by an efficiency control circuit 930 based on measured battery voltages from the electric vehicles 902 and 902*.

The DC-DC converters 920A and 920B can each have a resonant topology, including a variable transformer. The variable transformer can have a primary side coupled to a DC-AC circuit, and a secondary side coupled to an AC-DC circuit. The DC-DC converters 920A and 920B can each include a switching circuit configured to generate switching signals having switching frequencies and duty cycles for the DC-AC circuit and the AC-DC circuit, together with a phase shift between the DC-AC circuit and the AC-DC circuit.

The efficiency control circuit 930 is also configured to generate control signals 932A and 932B for changing a transformer ratio of the variable transformers of the DC-DC converters. The control signals 932A and 932B are also configured to control a power transfer flow direction of the DC-DC converters 920A and 920B, for example, by varying the phase shift between the portions of the DC-DC converters. For example, the DC-DC converter 920A can be configured to have a reverse power flow, and the DC-DC converter 920B can be configured to have a forward power flow, which can enable a charging of the electric vehicle 902* from the battery power of the electric vehicle 902.

The controller can determine an optimized common voltage at the output of the AC-DC converter. The determination of a common voltage can be an iteration process, based on the determination of maximum efficiency of individual DC-DC converters. After the common voltage value is determined the controller then sends signals to the transformer and the AC-DC converter to set the transformer ratio and the voltage gain of the AC-DC converter, respectively.

In addition, the control signals can include a signal to adjust the switching frequency of the DC-DC converters to reduce a current stress in the DC-DC converters, such as when the voltage measured from the electric vehicle is in a range of 50V-150V.

FIG. 17B shows an operation of a vehicle-to-vehicle charging. Operation 1700 couples two electric vehicles to outputs of two bidirectional DC-DC converters of a charger for vehicle-to-vehicle charging. Operation 1701 determines voltages of the electric vehicles. 902 controls phase shifts of a DC-DC converter to enable vehicle-to-vehicle charging.

Operation 1703 controls at least one of a transformer ratio or a switching signal of each DC-DC converter to optimize efficiencies of the DC-DC converters. The efficiency is optimized by providing a gain of the DC-DC converter to be in a vicinity of a winding ratio of a transformer in the DC-DC converter. The efficiency is further optimized by varying the switching frequency of the DC-DC converter.

Operation 1704 determines a voltage at a DC link capacitor to optimize the efficiencies at the two DC-DC converters. Operation 1705 connects the DC-DC converter outputs to the vehicles to transfer power between the vehicles.

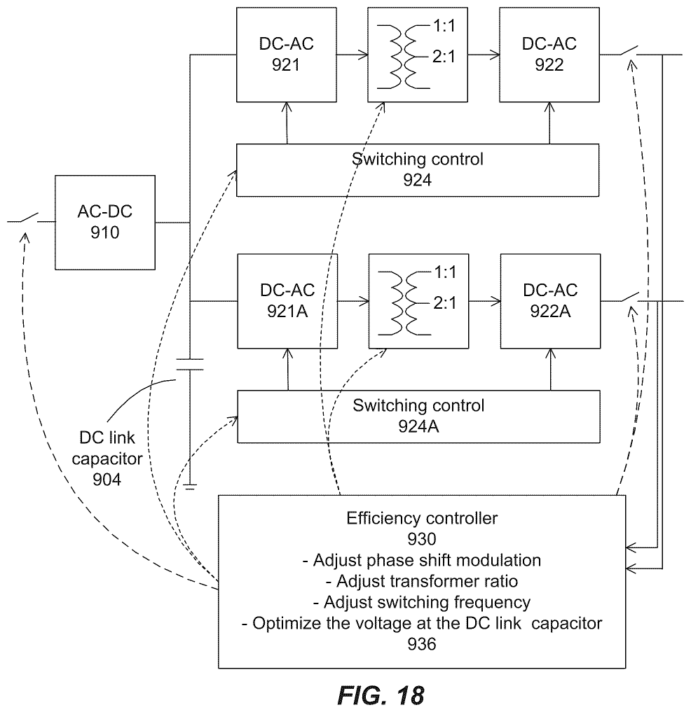

FIG. 18 illustrates a schematic with an operating sequence for a charger capable of vehicle-to-vehicle charging according to some embodiments. A charger, e.g., a power converter module, can include one AC-DC converter coupled to two DC-DC converters with a DC link capacitor disposed in between. The outputs of the DC-DC converters can be coupled together by a circuit configured to connect the outputs together for parallel charging an electric vehicle. Each DC-DC converter can include a transformer having multiple arrangeable windings, which can be arranged to provide a transformer having multiple different turn ratios. The outputs of the DC-DC converters each can be coupled to a controllable switch which is coupled to an output of the charger. The inputs of the charger can be coupled to controllable switches.

The charger can include a controller, such as an efficiency control circuit 930, which is configured to maximize performance and efficiency of the charger based on the battery voltages measured from the electric vehicles coupled to the charger.

In operation, the controller can determine the mode of operation, for example, charging an electric vehicle. The controller then determines the source of power to be delivered to the electric vehicle to be charged. For example, during an off-peak time in which the price of electricity is low, or when there is no other source of power available, the charger can use the grid power to charge the electric vehicle.

Further, the charger can determine to use full power or half power to charge the electric vehicle. For example, when there is only one electric vehicle coupled to the charger, the charger can charge the electric vehicle using the full power. During the charging, if another electric vehicle is coupled to the charger, the charger can drop the power delivered to the first electric vehicle to half the power, and using the remaining half of the power to charge the second electric vehicle.

Alternatively, the charger can determine to use the power of another electric vehicle, also coupled to the charger, to charge the first electric vehicle. For example, when the grid power is temporarily unavailable, or when the charger is installed in area with no grid power, a service vehicle, positioned nearby, can be driven up to the charger so that the charger can use the power from the service vehicle to charge the first electric vehicle. The charger can be installed in a short term or long term parking garage, with multiple electric vehicles parked around the charger. During peak hours when the cost of electricity is high, a long term parked vehicle can be driven up to the charger so that the charger can use the power from the long term parked vehicle to charge the first electric vehicle. The long term parked vehicle can be re-charged at night, or at a time when the cost of electricity is low.

After determining that a V2V charging process will be performed to charge the electric vehicle desired to be charged, the controller can set the power flow directions for the DC-DC converters, such as setting a forward power flow to the DC-DC converter coupled to the electric vehicle to be charged, and setting a reverse power flow to the DC-DC converter coupled to the electric vehicle to be discharged.

The controller can determine an optimized common voltage at the output of the AC-DC converter. The determination of a common voltage can be an iteration process, based on the determination of maximum efficiency of individual DC-DC converters. After the common voltage value is determined the controller then sends signals to the transformer and the AC-DC converter to set the transformer ratio and the voltage gain of the AC-DC converter, respectively.

In addition, the control signals can include a signal to adjust the switching frequency of the DC-DC converters to reduce a current stress in the DC-DC converters, such as when the voltage measured from the electric vehicle is in a range of 50V-150V.

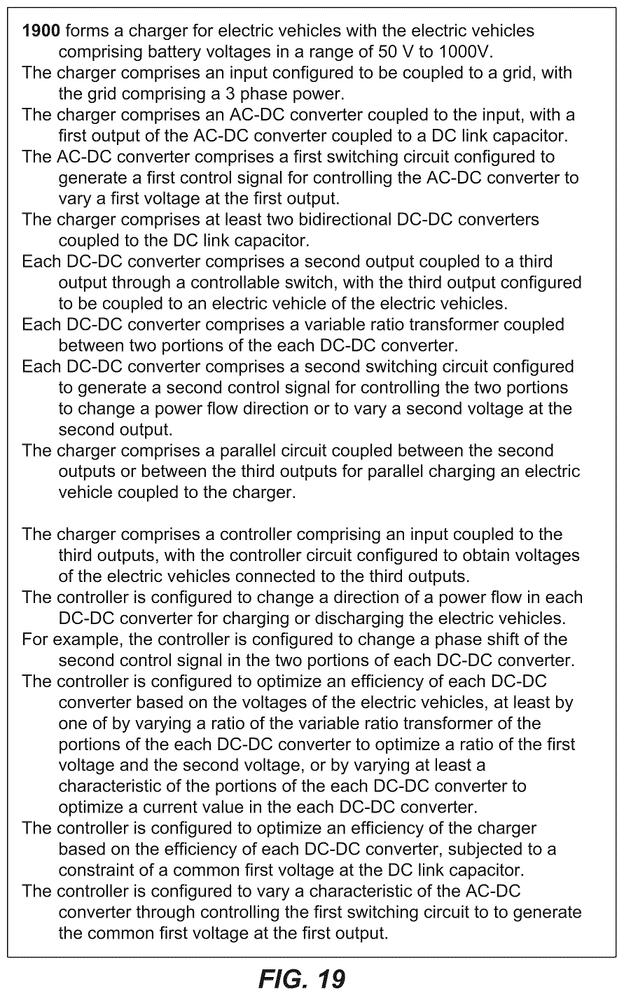

FIG. 19 illustrates a flow chart for forming a charger capable of vehicle-to-vehicle charging according to some embodiments. Operation 1900 forms a charger for electric vehicles with the electric vehicles comprising battery voltages in a range of 50 V to 1000V. The charger comprises an input configured to be coupled to a grid, with the grid comprising a 3 phase power. The charger comprises an AC-DC converter coupled to the input, with a first output of the AC-DC converter coupled to a DC link capacitor. The AC-DC converter comprises a first switching circuit configured to generate a first control signal for controlling the AC-DC converter to vary a first voltage at the first output.

The charger comprises at least two bidirectional DC-DC converters coupled to the DC link capacitor. Each DC-DC converter comprises a second output coupled to a third output through a controllable switch, with the third output configured to be coupled to an electric vehicle of the electric vehicles. Each DC-DC converter comprises a variable ratio transformer coupled between two portions of the each DC-DC converter. Each DC-DC converter comprises a second switching circuit configured to generate a second control signal for controlling the two portions to change a power flow direction or to vary a second voltage at the second output.

The charger comprises a parallel circuit coupled between the second outputs or between the third outputs for parallel charging an electric vehicle coupled to the charger.

The charger comprises a controller comprising an input coupled to the third outputs, with the controller circuit configured to obtain voltages of the electric vehicles connected to the third outputs. The controller is configured to change a direction of a power flow in each DC-DC converter for charging or discharging the electric vehicles. For example, the controller is configured to change a phase shift of the second control signal in the two portions of each DC-DC converter.

The controller is configured to optimize an efficiency of each DC-DC converter based on the voltages of the electric vehicles, at least by one of by varying a ratio of the variable ratio transformer of the portions of the each DC-DC converter to optimize a ratio of the first voltage and the second voltage, or by varying at least a characteristic of the portions of the each DC-DC converter to optimize a current value in the each DC-DC converter.

The controller is configured to optimize an efficiency of the charger based on the efficiency of each DC-DC converter, subjected to a constraint of a common first voltage at the DC link capacitor.

The controller is configured to vary a characteristic of the AC-DC converter through controlling the first switching circuit to generate the common first voltage at the first output.

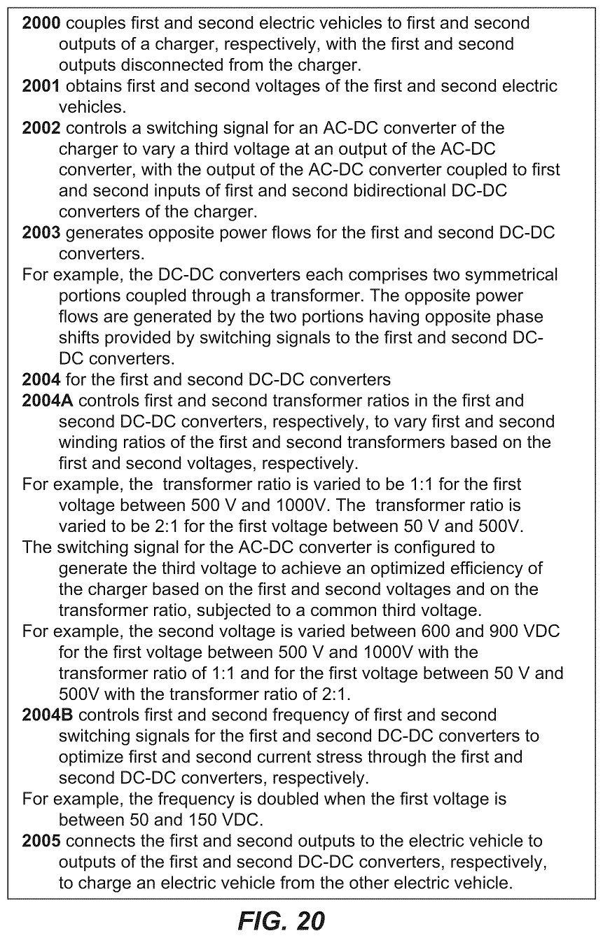

FIG. 20 illustrates a flow chart for vehicle-to-vehicle charging using a charger capable of vehicle-to-vehicle charging according to some embodiments. Operation 2000 couples first and second electric vehicles to first and second outputs of a charger, respectively, with the first and second outputs disconnected from the charger. Operation 2001 obtains first and second voltages of the first and second electric vehicles.

Operation 2002 controls a switching signal for an AC-DC converter of the charger to vary a third voltage at an output of the AC-DC converter, with the output of the AC-DC converter coupled to first and second inputs of first and second bidirectional DC-DC converters of the charger.

Operation 2003 generates opposite power flows for the first and second DC-DC converters. For example, each DC-DC converter comprises two symmetrical portions coupled through a transformer. The opposite power flows are generated by the two portions having opposite phase shifts provided by switching signals to the first and second DC-DC converters.

Operation 2004 configures the first and second DC-DC converters. Operation 2004A controls first and second transformer ratios in the first and second DC-DC converters, respectively, to vary first and second winding ratios of the first and second transformers based on the first and second voltages, respectively. For example, the transformer ratio is varied to be 1:1 for the first voltage between 500 V and 1000V. The transformer ratio is varied to be 2:1 for the first voltage between 50 V and 500V. The switching signal for the AC-DC converter is configured to generate the third voltage to achieve an optimized efficiency of the charger based on the first and second voltages and on the transformer ratio, subjected to a common third voltage. For example, the second voltage is varied between 600 and 900 VDC for the first voltage between 500 V and 1000V with the transformer ratio of 1:1 and for the first voltage between 50 V and 500V with the transformer ratio of 2:1.

Operation 2004B controls first and second frequency of first and second switching signals for the first and second DC-DC converters to optimize first and second current stress through the first and second DC-DC converters, respectively. For example, the frequency is doubled when the first voltage is between 50 and 150 VDC.

Operation 2005 connects the first and second outputs to the electric vehicle to outputs of the first and second DC-DC converters, respectively, to charge an electric vehicle from the other electric vehicle.

For convenience, “top”, “bottom”, “above”, “below” and similar descriptors are used merely as points of reference in the description, and while corresponding to the general orientation of the illustrated system during operation, are not to be construed to limit the orientation of the system during operation or otherwise.

In the specification, the statement that two or more parts are “coupled” together shall mean that the parts are joined or connected together either directly or through one or more intermediate parts.

In the specification, the term “switch” means any switch suitable for use in an electrical circuit. The term includes both mechanical type switches and electrical switches, such as relays or solid state type switches such as MOSFETs.

What is claimed is:

1. A charger for electric vehicles comprising:
a first input configured to be coupled to a grid;
two or more first outputs, with each first output configured to be coupled to an electric vehicle;
an alternating current-direct current (AC-DC) converter,
wherein the AC-DC converter comprises a first switching circuit comprising a second input coupled to the first input,
wherein the AC-DC converter comprises a first control circuit configured to provide a first switching signal to the first switching circuit to vary a first voltage at a second output of the AC-DC converter in a defined range,
two or more bidirectional direct current-direct current (DC-DC) converters,
wherein each DC-DC converter comprises a variable transformer coupled between a second switching circuit and a third switching circuit, with the second switching circuit comprising a third input coupled to the second output, and with the third switching circuit comprising a third output,
wherein each DC-DC converter comprises a second control circuit configured to provide second and third switching signals to the second and third switching circuits, respectively;
two or more controllable switches,
wherein each controllable switch is coupled between a third output of the two or more DC-DC converters and a first output of the two or more first outputs;
a controller,
wherein the controller is coupled to the two or more first outputs for obtaining a second voltage of each electric vehicle of the electric vehicles coupled to the two or more first outputs,
wherein the controller is configured to optimize an individual efficiency of a first DC-DC converter based on a first second voltage obtained from a first electric vehicle when the charger is configured to charge the first electric vehicle coupled to the first output connected to the first DC-DC converter,
wherein the controller is configured to optimize an efficiency of the charger based on individual efficiencies of the two or more DC-DC converters, subjected to a constraint of a common first voltage for the two or more DC-DC converters, when the charger is configured to charge two or more electric vehicles coupled to the two or more first outputs connected to the two or more DC-DC converter.

2. The power conversion module of claim 1,
wherein the individual efficiency is optimized by varying at least one of the first voltage or a ratio of the transformer to obtain a ratio of the first voltage and the first second voltage to be in a vicinity of a winding ratio of the transformer,
wherein the individual efficiency is optimized by varying a switching frequency of the second and third switching circuits of the first DC-DC converter to obtain a reduction in current in the first DC-DC converter when a ratio of the first voltage and the first second voltage deviates more than twice a winding ratio of the transformer.

3. A power conversion module as in claim 1,
wherein the individual efficiency is optimized by changing a ratio of the transformer of the first DC-DC converter to be between 1:1 and 2:1,
wherein the ratio is at 1:1 when the first second voltage is within the defined,
wherein the ratio is at 2:1 when the first second voltage is within half of the defined range.

4. The power conversion module of claim 1,
wherein the defined range is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC.

5. The power conversion module of claim 1,
wherein only the first electric vehicle is coupled to the charger,
wherein the defined rage is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC,
wherein a switching frequency of the second and third switching circuits of the first DC-DC converter is doubled when the battery voltage of the first electric vehicle is between 50 to 150 VDC.

6. The power conversion module of claim 1,
wherein the charger efficiency is optimized based on a reevaluation of the individual efficiency of each DC-DC converter of the two or more DC-DC converters to achieve the common first voltage.

7. The power conversion module of claim 1,
wherein the charger is configured to charge two or more electric vehicles simultaneously,
wherein the individual efficiency is estimatedly optimized by varying at least one of the first voltage, a ratio of the transformer, or a switching frequency of the second and third switching circuits of the first DC-DC converter,
wherein the charger efficiency is optimized based on a reevaluation of the estimatedly optimized individual efficiency of each DC-DC converter of the two or more DC-DC converters to achieve the common first voltage.

8. The power conversion module of claim 1,
wherein the charger is configured to charge two or more electric vehicles simultaneously,
wherein the defined rage is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC,
wherein a switching frequency of the second and third switching circuits of the first DC-DC converter is doubled when the battery voltage of the first electric vehicle is between 50 to 150 VDC,
wherein the individual efficiency is estimatedly optimized by varying at least one of the first voltage, a ratio of the transformer, or a switching frequency of the second and third switching circuits of the first DC-DC converter,
wherein the charger efficiency is optimized based on a reevaluation of the estimatedly optimized individual efficiency of each DC-DC converter of the two or more DC-DC converters to achieve the common first voltage.

9. The power conversion module of claim 1,
a parallel circuit coupled between at least two third outputs of the two or more DC-DC converters or between at least two first outputs of the two or more first outputs,
wherein the controller is configured to control the parallel circuit to connect the at least two third outputs or the at least two first outputs to provide doubled power charging to charge a second electric vehicle when the second electric vehicle is coupled to one of the at least two first outputs.

10. The power conversion module of claim 1,
wherein the controller is configured to provide different phase shift directions in the second and third switching circuits between two of the DC-DC converters to enable charging between two electric vehicles coupled to the first outputs.

11. The power conversion module of claim 1,
wherein the controller is configured to provide a negative phase shift in the second and third switching circuits of the first DC-DC converter, and a positive phase shift in the second and third switching circuits of a second DC-DC converter to enable charging from a first electric vehicle coupled to a first output coupled to the first DC-DC converter to a second electric vehicle coupled to a second output coupled to a second DC-DC converter,
wherein the individual efficiency is estimatedly optimized by varying at least one of the first voltage, a ratio of the transformer, or a switching frequency of the second and third switching circuits of the two or more DC-DC converters,
wherein the charger efficiency is optimized based on a reevaluation of the estimatedly optimized individual efficiency of each DC-DC converter of the two or more DC-DC converters to achieve the common first voltage.

12. The power conversion module of claim 1,
wherein the controller is configured to provide a negative phase shift in the second and third switching circuits of the first DC-DC converter, and a positive phase shift in the second and third switching circuits of a second DC-DC converter to enable charging from a first electric vehicle coupled to a first output coupled to the first DC-DC converter to a second electric vehicle coupled to a second output coupled to a second DC-DC converter,
wherein the defined rage is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC,
wherein a switching frequency of the second and third switching circuits of the first DC-DC converter is doubled when the battery voltage of the first electric vehicle is between 50 to 150 VDC,
wherein the charger efficiency is optimized based on an optimization of individual efficiency of each DC-DC converter of the two or more DC-DC converters subjected to a common first voltage.

13. The power conversion module of claim 1,
wherein the controller is configured to control the controllable switch to turn off the controllable switch for obtaining the second voltages.

14. The power conversion module of claim 1,
wherein the variable transformer comprises a transformer coupled to a ratio control circuit configured to change a turn ratio of the transformer.

15. A charger for electric vehicles comprising:
a first input configured to be coupled to a grid;
two first outputs, with the first outputs configured to be coupled to first and second electric vehicles, repectively;
an alternating current-direct current (AC-DC) converter,
wherein the AC-DC converter comprises a first switching circuit comprising a second input coupled to the first input,
wherein the AC-DC converter comprises a first control circuit configured to provide a first switching signal to the first switching circuit to vary a first voltage at a second output of the AC-DC converter in a defined range,
two bidirectional direct current-direct current (DC-DC) converters,
wherein each DC-DC converter comprises a variable transformer coupled between a second switching circuit and a third switching circuit, with the second switching circuit comprising a third input coupled to the second output, and with the third switching circuit comprising a third output,
wherein each DC-DC converter comprises a second control circuit configured to provide second and third switching signals to the second and third switching circuits, respectively;
two controllable switches,
wherein each controllable switch is coupled between a third output of the two DC-DC converters and a first output of the two first outputs;
a parallel circuit coupled between the third outputs or between the first outputs and configured to be connectable between the third outputs or between the first outputs, respectively,
a controller,
wherein the controller is coupled to the two first outputs for obtaining a second voltage of each of the first and second electric vehicles coupled to the two first outputs,
wherein the controller is configured to provide charging of one electric vehicle from another vehicle of the first and second electric vehicles when the first and second electric vehicles are coupled to the two first outputs, respectively,
wherein the controller is configured to provide different phase shift directions between the two DC-DC converters,
wherein the controller is configured to estimately optimize efficiencies of the first and second DC-DC converters based on the second voltages obtained from the first and second electric vehicles,
wherein the efficiencies of the first and second DC-DC converters are estimately optimized by varying at least one of the first voltage or a ratio of the transformer to obtain a ratio of the first voltage and the first second voltage to be in a vicinity of a winding ratio of the transformer,
wherein the efficiencies of the first and second DC-DC converters are further estimately optimized by varying a switching frequency of the second and third switching circuits of the first or second DC-DC converters to obtain a reduction in current in the first or second DC-DC converters when a ratio of the first voltage and the first second voltage or a ratio of the first voltage and the second second voltage deviates more than twice a winding ratio of the transformer, respectively,
wherein the controller is configured to optimize an efficiency of the charger based on the estimated efficiencies of the first and second DC-DC converter subjected to a constraint of a common first voltage at the second output of the AC-DC converter.

16. The power conversion module of claim 15,
wherein the controller is configured to provide charging for the first electric vehicle with power from the first DC-DC converter when the first electric vehicle is coupled to a first first output,
wherein the controller is configured to optimize an efficiency of the first DC-DC converter based on a first second voltage obtained from the first electric vehicle,
wherein the efficiency of the first DC-DC converter is optimized by varying at least one of the first voltage or a ratio of the transformer to obtain a ratio of the first voltage and the first second voltage to be in a vicinity of a winding ratio of the transformer,
wherein the efficiency of the first DC-DC converter is further optimized by varying a switching frequency of the second and third switching circuits of the first DC-DC converter to obtain a reduction in current in the first DC-DC converter when a ratio of the first voltage and the first second voltage deviates more than twice a winding ratio of the transformer,
wherein the controller is configured to provide charging for the first electric vehicle with power from the first and second DC-DC converters when the first electric vehicle is coupled to a first first output,
wherein the controller is configured to control the parallel circuit to connect the first outputs or the third outputs,
wherein the controller is configured to optimize efficiencies of the first and second DC-DC converters based on a first second voltage obtained from the first electric vehicles,
wherein the efficiency of the first DC-DC converter is optimized by varying at least one of the first voltage or a ratio of the transformer to obtain a ratio of the first voltage and the first second voltage to be in a vicinity of a winding ratio of the transformer,
wherein the efficiency of the first DC-DC converter is further optimized by varying a switching frequency of the second and third switching circuits of the first DC-DC converter to obtain a reduction in current in the first DC-DC converter when a ratio of the first voltage and the first second voltage deviates more than twice a winding ratio of the transformer,
wherein the controller is configured to provide charging of the first and second electric vehicles simultaneously when the first and second electric vehicles are coupled to the two first outputs, respectively,
wherein the controller is configured to estimately optimize efficiencies of the first and second DC-DC converters based on the second voltages obtained from the first and second electric vehicles,
wherein the efficiencies of the first and second DC-DC converters are estimately optimized by varying at least one of the first voltage or a ratio of the transformer to obtain a ratio of the first voltage and the first second voltage to be in a vicinity of a winding ratio of the transformer,
wherein the efficiencies of the first and second DC-DC converters are further estimately optimized by varying a switching frequency of the second and third switching circuits of the first or second DC-DC converters to obtain a reduction in current in the first or second DC-DC converters when a ratio of the first voltage and the first second voltage or a ratio of the first voltage and the second second voltage deviates more than twice a winding ratio of the transformer, respectively,
wherein the controller is configured to optimize an efficiency of the charger based on the estimated efficiencies of the first and second DC-DC converter subjected to a constraint of a common first voltage at the second output of the AC-DC converter.

17. The power conversion module of claim 15,
wherein only the first electric vehicle is coupled to the charger,
wherein the defined rage is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC,
wherein a switching frequency of the second and third switching circuits of the first DC-DC converter is doubled when the battery voltage of the first electric vehicle is between 50 to 150 VDC.

18. The power conversion module of claim 15,
wherein the charger is configured to charge two or more electric vehicles simultaneously,
wherein the defined rage is between 600 and 900 VDC,
wherein the ratio of the transformer of the first DC-DC converter is set at 1:1 when battery voltage of the first electric vehicle is between 500 and 1000 VDC,
wherein the ratio of the transformer of the first DC-DC converter is set at 2:1 when the battery voltage of the first electric vehicle is between 50 to 500 VDC,
wherein a switching frequency of the second and third switching circuits of the first DC-DC converter is doubled when the battery voltage of the first electric vehicle is between 50 to 150 VDC,
wherein the individual efficiency is estimatedly optimized by varying at least one of the first voltage, a ratio of the transformer, or a switching frequency of the second and third switching circuits of the first DC-DC converter,
wherein the charger efficiency is optimized based on a reevaluation of the estimatedly optimized individual efficiency of each DC-DC converter of the two or more DC-DC converters to achieve the common first voltage.

19. A method for charging electric vehicles, the method comprising:
coupling at least a first electric vehicle or a second electric vehicle to a charger,
wherein the charger comprises a first input configured to be coupled to a grid,
wherein the charger comprises two first outputs, with the first outputs configured to be coupled to the first and second electric vehicles, repectively;
wherein the charger comprises an alternating current-direct current (AC-DC) converter,
wherein the AC-DC converter comprises a first switching circuit comprising a second input coupled to the first input,
wherein the AC-DC converter comprises a first control circuit configured to provide a first switching signal to the first switching circuit to vary a first voltage at a second output of the AC-DC converter in a defined range,
wherein the charger comprises two bidirectional direct current-direct current (DC-DC) converters,
wherein each DC-DC converter comprises a variable transformer coupled between a second switching circuit and a third switching circuit, with the second switching circuit comprising a third input coupled to the second output, and with the third switching circuit comprising a third output,
wherein each DC-DC converter comprises a second control circuit configured to provide second and third switching signals to the second and third switching circuits, respectively;
two controllable switches,
wherein each controllable switch is coupled between a third output of the two DC-DC converters and a first output of the two first outputs;
a parallel circuit coupled between the third outputs or between the first outputs and configured to be connectable between the third outputs or between the first outputs, respectively,
for the first and second electric vehicle coupled to the charger for using the first electric vehicle to charge the second electric vehicle, the method further comprising
obtaining the second voltage from the first electric vehicle,
obtaining a third voltage from the second electric vehicle,
wherein the controller is configured to provide a first phase shift to the first DC-DC converter to enable discharging of the first electric vehicle,
wherein the controller is configured to provide a second phase shift, opposite to the first phase shift, to the second DC-DC converter to enable charging of the second electric vehicle,
wherein the controller is configured to estimately optimize efficiencies of the first and second DC-DC converters based on the second and third voltages,
wherein the efficiencies of the first and second DC-DC converters are estimately optimized by varying at least one of the first voltage or a ratio of the transformer in each of the first and second DC-DC converters to obtain a ratio of the first voltage and the second voltage to be in a vicinity of a winding ratio of the transformer, respectively,
wherein the efficiencies of the first and second DC-DC converters are further estimately optimized by varying a switching frequency of the first and second DC-DC converters to obtain a reduction in current in the first and second DC-DC converters when a ratio of the first voltage and the first second voltage deviates more than twice a winding ratio of the transformer, respectively,
wherein the controller is configured to optimize an efficiency of the charger based on the estimated efficiencies of the first and second DC-DC converter subjected to a constraint of a common first voltage.

20. The method of claim 19,
for only the first electric vehicle coupled to the charger to be charged by the first DC-DC converter, the method further comprising:
obtaining a second voltage from the first electric vehicle,
optimizing an efficiency of the first DC-DC converter based on the second voltage,
wherein the efficiency of the first DC-DC converter is optimized by varying at least one of the first voltage or a ratio of the transformer to obtain a ratio of the first voltage and the first second voltage to be in a vicinity of a winding ratio of the transformer,
wherein the efficiency of the first DC-DC converter is further optimized by varying a switching frequency of the second and third switching circuits of the first DC-DC converter to obtain a reduction in current in the first DC-DC converter when a ratio of the first voltage and the first second voltage deviates more than twice a winding ratio of the transformer,
for only the first electric vehicle coupled to the charger to be charged by the first and second DC-DC converters, the method further comprising
controlling the parallel circuit to connect the two first outputs or to connect the third outputs,
obtaining the second voltage from the first electric vehicle,
wherein the controller is configured to optimize efficiencies of the first and second DC-DC converters based on the second voltage,
wherein the efficiencies of the first and second DC-DC converters are optimized by varying at least one of the first voltage or a ratio of the transformer in each of the first and second DC-DC converters to obtain a ratio of the first voltage and the second voltage to be in a vicinity of a winding ratio of the transformer, respectively,
wherein the efficiencies of the first and second DC-DC converters are further optimized by varying a switching frequency of the first and second DC-DC converters to obtain a reduction in current in the first and second DC-DC converters when a ratio of the first voltage and the first second voltage deviates more than twice a winding ratio of the transformer, respectively,
for the first and second electric vehicle coupled to the charger to be charged simultaneously, the method further comprising
obtaining the second voltage from the first electric vehicle,
obtaining a third voltage from the second electric vehicle,
wherein the controller is configured to estimately optimize efficiencies of the first and second DC-DC converters based on the second and third voltages,
wherein the efficiencies of the first and second DC-DC converters are estimately optimized by varying at least one of the first voltage or a ratio of the transformer in each of the first and second DC-DC converters to obtain a ratio of the first voltage and the second voltage to be in a vicinity of a winding ratio of the transformer, respectively,
wherein the efficiencies of the first and second DC-DC converters are further estimately optimized by varying a switching frequency of the first and second DC-DC converters to obtain a reduction in current in the first and second DC-DC converters when a ratio of the first voltage and the first second voltage deviates more than twice a winding ratio of the transformer, respectively,
wherein the controller is configured to optimize an efficiency of the charger based on the estimated efficiencies of the first and second DC-DC converter subjected to a constraint of a common first voltage.
